(19) United States
(12) Patent Application Publication
(10) Pub. No.: US 2025/0175822 A1
(43) Pub. Date: May 29, 2025

(54) INTERFERENCE MEASUREMENT RESOURCE CAPABILITY AND CONFIGURATION REPORTING

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Arumugam CHENDAMARAI KANNAN, San Diego, CA (US)

(21) Appl. No.: 18/523,589

(22) Filed: Nov. 29, 2023

(51) Int. Cl. H04W 24/08; H04W 24/02

(52) U.S. Cl. CPC H04W 24/08; H04W 24/02

(57) ABSTRACT

Systems and techniques are provided for wireless communications. For instance, a process can include obtaining information indicative of one or more configured performance values corresponding to interference prediction by a user equipment (UE). A recommended configuration of interference measurement resources (IMRs) and interference prediction resources for the interference prediction by the UE can be determined, wherein the recommended configuration is associated with the one or more configured performance values and one or more performance capabilities of an interference prediction machine learning network associated with the UE. The UE can transmit, to the network entity, information indicative of the recommended configuration for the interference prediction by the UE.

### FIELD

The present disclosure generally relates to wireless communications. For example, aspects of the present disclosure relate to systems and techniques for reporting information associated with interference measurement and/or prediction resources.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Wireless communications networks can utilize various techniques to perform uplink and downlink transmission between network entities and/or user equipment (UE). Transmissions to and/or from different network entities, UEs, cells, etc., can interfere with one or more other transmissions. For instance, an uplink transmission by a first UE can interfere with a downlink reception by a second UE if the uplink transmission and the downlink reception are scheduled to use the same frequency at the same time. In some cases, interference variation can occur when interference changes over time. For instance, the interference associated with the uplink and/or downlink transmissions of a UE and/or other network entity (e.g., base station, gNB, etc.) can experience interference variation corresponding to changes in the interference between the UE and network entity over time. In some cases, interference variation may reduce the performance of a wireless communication network.

For instance, interference measurements may be determined by a UE and reported (e.g., transmitted) from the UE to a base station. The base station can utilize the interference measurements received from the UE to determine and/or perform scheduling for the UE, where the upcoming scheduling for the UE is based at least in part on the UE's interference measurements. Scheduling performed for a UE and based on the last measured interference for the UE can be referred to as sample and hold. Using sample and hold to serve a UE can reduce the performance (e.g., can decrease throughput, increase latency, etc.) of the wireless communication network. For instance, sample and hold can be associated with a time delay between the UE first determining the interference measurements and later receiving (e.g., from the base station) scheduling based on the UE's last reported interference measurements. The delay associated with serving a UE using sample and hold can cause a mismatch between the actual interference at a UE and the last reported interference used by the base station to perform scheduling for the UE. In some examples, mismatched or different interference measurements between the UE and the base station can correspond to reduced wireless network performance and/or an increased interference variation and/or relatively rapid interference variation (e.g., interference changing over a shorter period of time than the delay between the UE interference measurement report and the corresponding scheduling performed by the base station).

In some examples, interference prediction may be performed by a UE and/or by a base station to reduce the variation between the interference measured and reported by the UE and the UE scheduling based on the determined interference. For instance, a base station can perform UE scheduling based on an interference prediction for the UE (e.g., one or more predicted interference measurements for the UE), rather than an interference measurement determined by the UE and reported to the base station. In some cases, interference prediction may be based on a predicted interference covariance matrix and/or a predicted interference power, which can be determined using one or more artificial intelligence (AI) and/or machine learning (ML) networks. Using the ML-based interference prediction for the UE, more advanced scheduling and/or link adaptation techniques may be used to serve the UE and increase the network's throughput and/or latency. For example, interference prediction can be a non-linear task, where various configuration parameters at multiple different network locations (e.g., neighboring cells, etc.) can have an impact on the temporal, frequency, and/or spatial correlation of the inter-cell interference observed at a UE. For example, inter-cell interference for a UE can vary with the configuration of scheduling behavior for each respective cell of a group of neighboring cells and/or may vary based on configuration parameters such as the number of active UEs, the traffic type(s) at the neighboring cells, loading and/or resource utilization (RU), beam management, etc. In some aspects, interference variations associated with a UE may further be based on channel variations (e.g., between interfering cells and the UE).

Interference prediction accuracy and/or confidence level information associated with the interference prediction can be based on the type of interference measurement resources (IMRs), the periodicity of IMRs, the number of IMRs, and/or patterns of the IMRs. In some cases, interference prediction accuracy and/or confidence level information can additionally be based on a time separation between the interference measurement and prediction resources. Serving (e.g., performing scheduling for) a UE based on inaccurate or low-confidence interference predictions can reduce network performance (e.g., throughput, latency, etc.). There is a need for systems and techniques that can be used to provide reporting between a UE and a network entity (e.g., base station, gNB, etc.) of information indicative of UE IMR capabilities. There is a further need for systems and techniques that can be used to provide reporting information indicative of the accuracy and/or confidence level associated with a UE interference prediction.

Systems, apparatuses, processes (also referred to as methods), and computer-readable media (collectively referred to as “systems and techniques”) are described herein for improved and enhanced reporting of interference prediction capabilities and performance information associated with a UE. In some aspects, the systems and techniques can be used to provide interference measurement resource (IMR) capability and configuration reporting between a UE and a network entity (e.g., base station, gNB, etc.). In some aspects, an IMR report generated and transmitted by a UE can be indicative of the IMR capabilities of the UE. In some examples, the IMR report can be indicative of an accuracy and/or confidence level associated with interference prediction corresponding to the UE. In some aspects, a UE can transmit information indicative of a requested or recommended IMR configuration for interference measurement and/or interference prediction that will be performed by the UE. In some aspects, a UE can transmit information indicative of an accuracy or level of confidence associated with interference measurement prediction performed by the UE, based on one or more of the type, the periodicity, the number of IMRs and/or interference prediction resources configured by the network entity, etc. In some aspects, the UE can transmit an IMR report or other information indicative of the UE interference prediction capabilities, where the UE interference prediction capabilities correspond to a respective accuracy and/or confidence level of the UE interference prediction when the network entity allocates different combinations or configurations of IMRs and/or interference prediction resources for performing the UE interference prediction.

In some aspects, a UE can be configured to perform interference prediction based on a combination of one or more previous interference measurements by the UE and/or one or more previous interference predictions by the UE. Different configurations of the type, periodicity, number, and patterns of the IMRs used by the UE to obtain interference measurements, and the time separation between the interference measurement and prediction resources allocated for the UE, can correspond to different performance levels (e.g., accuracy and/or confidence) of the corresponding interference prediction by the UE. In some aspects, a network entity can configure a UE with IMRs or interference prediction resources for interference prediction based on the one or more IMR configurations and/or capabilities reported by the UE to the network entity. In some aspects, the UE can report to the network entity a recommended or requested configuration of measurement and prediction resources that can be used by the UE to meet configured interference prediction performance and/or confidence level thresholds. In some aspects, the UE can transmit to the network entity information indicative of the UE interference measurement and prediction capabilities, and the network entity can determine and configure interference measurement and prediction resources for the UE based on analyzing the reported UE interference measurement and prediction capabilities. In some aspects, the UE can be configured to report a recommended or requested configuration of interference measurement and prediction resources and/or interference prediction capability information of the UE, corresponding to various thresholds on the separation between the interference prediction resources and the interference measurement resources. For instance, the UE can report resource configuration recommendation information and/or interference prediction performance information corresponding to different time values of the separation between successive IMRs and interference prediction resources. In some cases, the UE interference prediction performance information can be indicative of a mean square error (MSE) or various other accuracy measures of the UE interference prediction. In some examples, the UE interference prediction performance information can be indicative of a level of confidence in the UE interference prediction.

According to at least one illustrative example, a method of wireless communication performed at a user equipment (UE) is provided. The method includes: obtaining information indicative of one or more configured performance values corresponding to interference prediction by the UE; determining a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and transmitting, to the network entity, information indicative of the recommended configuration for the interference prediction by the UE.

In another illustrative example, an apparatus of a user equipment (UE) for wireless communication is provided. The apparatus includes at least one memory and at least one processor coupled to the at least one memory and configured to: obtain information indicative of one or more configured performance values corresponding to interference prediction by the UE; determine a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and transmit, to the network entity, information indicative of the recommended configuration for the interference prediction by the UE.

In another illustrative example, a non-transitory computer-readable storage medium comprising instructions stored thereon which, when executed by at least one processor, causes the at least one processor to: obtain information indicative of one or more configured performance values corresponding to interference prediction by the UE; determine a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and transmit, to the network entity, information indicative of the recommended configuration for the interference prediction by the UE.

In another illustrative example, an apparatus is provided for wireless communication. The apparatus includes: means for obtaining information indicative of one or more configured performance values corresponding to interference prediction by the UE; means for determining a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and means for transmitting, to the network entity, information indicative of the recommended configuration for the interference prediction by the UE.

According to at least one illustrative example, a method of wireless communication performed at a network entity is provided. The method includes: transmitting, to a user equipment (UE), information indicative of one or more configured performance values corresponding to interference prediction by the UE; receiving, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and configuring a plurality of IMRs and interference prediction resources for the UE based on the information indicative of the recommended configuration.

In another illustrative example, an apparatus of a network entity for wireless communication is provided. The apparatus includes at least one memory and at least one processor coupled to the at least one memory and configured to: transmit, to a user equipment (UE), information indicative of one or more configured performance values corresponding to interference prediction by the UE; receive, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and configure a plurality of IMRs and interference prediction resources for the UE based on the information indicative of the recommended configuration.

In another illustrative example, a non-transitory computer-readable storage medium comprising instructions stored thereon which, when executed by at least one processor, causes the at least one processor to: transmit, to a user equipment (UE), information indicative of one or more configured performance values corresponding to interference prediction by the UE; receive, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and configure a plurality of IMRs and interference prediction resources for the UE based on the information indicative of the recommended configuration.

In another illustrative example, an apparatus is provided for wireless communication. The apparatus includes: means for transmitting, to a user equipment (UE), information indicative of one or more configured performance values corresponding to interference prediction by the UE; means for receiving, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and means for configuring a plurality of IMRs and interference prediction resources for the UE based on the information indicative of the recommended configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip examples or implementations, or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example of physical channels and reference signals in a wireless network, in accordance with some examples;

FIG. 6 is a diagram illustrating an example of a configuration of a wireless communication network where interference may occur, in accordance with some examples;

FIG. 7 is a diagram illustrating an example of interference prediction associated with a base station and a UE, in accordance with some examples;

FIG. 8A is a diagram illustrating an example of an interference measurement and prediction resource configuration based on a first UE interference measurement resource (IMR) capability information, in accordance with some examples;

FIG. 8B is a diagram illustrating an example of an interference measurement and prediction resource configuration based on a second UE IMR capability information, in accordance with some examples;

FIG. 9 is a signaling diagram corresponding to a process of wireless communication and interference prediction configuration between a network entity and a UE, in accordance with some examples;

FIG. 10 is a flow diagram illustrating example processes for wireless communication by a UE, in accordance with some examples;

FIG. 11 is a flow diagram illustrating an example process for wireless communication by a network entity, in accordance with some examples;

FIG. 12 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A wireless multiple-access communications network may employ various techniques for performing uplink transmission from and downlink reception to different user equipment (UE). In some examples, neighboring cells within the wireless communication network may have different configurations that may cause an overlap in conflicting communications, including between transmissions and/or receptions to and from UEs. For example, a wireless communication network utilizing time division duplexing (TDD) may include neighboring cells that have different TDD configurations, a network utilizing full duplexing (FD) may include neighboring cells that have different FD configurations, etc. For instance, an uplink transmission by a first UE may interfere (e.g., overlap) with a downlink reception by a second UE if the uplink transmission and the downlink reception are scheduled to use the same frequency at the same time.

Interference variation can occur when the interference associated with the uplink and/or downlink transmissions of a particular UE and/or other network entity (e.g., base station, gNB, etc.) changes over time. Interference variation can reduce the performance of a wireless communication network. For instance, interference measurements can be determined by a UE and subsequently reported (e.g., transmitted) from the UE to a base station. The base station can subsequently utilize the interference measurements received from the UE to determine and/or perform scheduling for the UE, where the upcoming scheduling for the UE is based at least in part on the UE's interference measurements. UE scheduling performed based on the last measured interference for a UE can be referred to as sample and hold.

Using sample and hold to serve a UE can reduce the performance of the wireless communication network (e.g., can decrease throughput, increase latency, etc.). For instance, sample and hold is associated with a time delay between the UE first determining the interference measurements and later receiving (e.g., from the base station) scheduling based on the UE's last reported interference measurements. The delay associated with serving a UE using sample and hold can cause a mismatch between the actual interference at a UE and the last reported interference used by the base station to perform scheduling for the UE. The mismatched or different interference measurements between the UE and the base station can correspond to the reduced wireless network performance noted above. In some cases, the interference mismatch may be associated with an increased interference variation and/or relatively rapid interference variation (e.g., interference changing over a shorter period of time than the delay between the UE interference measurement report and the corresponding scheduling performed by the base station).

In some examples, interference prediction can be performed by a UE and/or by a base station to reduce the delay between the determination of interference and the implementation of UE scheduling based on the determined interference. For instance, a base station can perform UE scheduling based on an interference prediction for the UE (e.g., one or more predicted interference measurements for the UE). In some cases, interference prediction can be based on a predicted interference covariance matrix and/or a predicted interference power. The predicted interference covariance matrix and/or predicted interference power can be determined using one or more artificial intelligence (AI) and/or machine learning (ML) networks. For example, interference prediction can be a highly non-linear task, as various configuration parameters at multiple different network locations (e.g., neighboring cells, etc.) can have an impact on the temporal, frequency, and/or spatial correlation of the inter-cell interference observed at a particular UE. For instance, the inter-cell interference measured for a particular UE can vary with the configuration of scheduling behavior for each respective cell of a group of neighboring cells (e.g., type of scheduler, such as proportional fair, round robin, etc.; scheduling granularity, such as mini-slot, slot, multi-slot, etc.). The inter-cell interference measured for a particular UE may additionally vary based on configuration parameters such as the number of active UEs, the traffic type(s) at the neighboring cells, loading and/or resource utilization (RU), beam management, etc. In some aspects, interference variations associated with a particular UE may further be based on channel variations (e.g., between interfering cells and the UE).

In some aspects, one or more AI and/or ML networks can be configured to learn the interference variation patterns from previous interference measurement resources (IMRs) and/or previous interference prediction resources for a particular UE. Using the ML-based interference prediction for the particular UE, more advanced scheduling and/or link adaptation techniques can be used to serve the particular UE and increase the network's throughput and/or latency.

Interference prediction accuracy and/or confidence level information associated with the interference prediction can be based on the type of IMRs, the periodicity of IMRs, the number of IMRs, and/or patterns of the IMRs. In some cases, interference prediction accuracy and/or confidence level information can additionally be based on a time separation between the interference measurement and prediction resources. Serving (e.g., performing scheduling for) a UE based on inaccurate or low-confidence interference predictions can reduce network performance (e.g., throughput, latency, etc.). There is a need for systems and techniques that can be used to provide reporting between a UE and a network entity (e.g., base station, gNB, etc.) of information indicative of UE IMR capabilities. There is a further need for systems and techniques that can be used to provide reporting information indicative of the accuracy and/or confidence level associated with a UE interference prediction.

Systems, apparatuses, processes (also referred to as methods), and computer-readable media (collectively referred to as “systems and techniques”) are described herein that can be used to provide interference measurement resource (IMR) capability and configuration reporting. For instance, the systems and techniques can be used to provide interference measurement resource capability and configuration reporting between a UE and a network entity (e.g., base station, gNB, etc.). In some aspects, an IMR report generated and transmitted by a UE can be indicative of the IMR capabilities of the UE. In some examples, the IMR report can be indicative of an accuracy and/or confidence level associated with interference prediction corresponding to the UE.

In some aspects, interference prediction can be performed by the UE and/or can be performed by a network entity (e.g., base station, gNB) associated with the UE. In one illustrative example, the UE can transmit an IMR report indicative of one or more IMR configurations for the UE. For example, the UE transmission can be indicative of a requested or recommended IMR configuration (e.g., configured and/or transmitted and/or scheduled by the network entity) for interference measurement and/or interference prediction that will be performed by the UE. In some aspects, the IMR report or UE transmission can be indicative of an accuracy or level of confidence associated with an interference measurement prediction by the UE, where the UE accuracy or level of confidence in the interference prediction is based on one or more of the type, the periodicity, and/or the number of interference measurement resources (IMRs) and/or interference prediction resources configured by the network entity. For instance, a UE with a relatively high interference prediction capability can meet a configured interference prediction accuracy or confidence level in its interference prediction using a smaller number of IMRs than needed by a UE with a relatively low interference prediction capability to meet the same configured interference prediction accuracy or confidence level.

In some aspects, the UE can transmit an IMR report or other information indicative of the UE interference prediction capabilities, where the UE interference prediction capabilities correspond to a respective accuracy and/or confidence level of the UE interference prediction when the network entity allocates (e.g., to or for the UE) different combinations or configurations of IMRs and/or interference prediction resources for performing the UE interference prediction. For instance, an IMR can be allocated to the UE as a physical or virtual element (e.g., network resources or resource elements, etc.) for measuring and/or determining interference levels during a corresponding time slot of the IMR. An interference prediction resource can be allocated or configured for the UE as a time slot or other period of time during which the UE can perform interference prediction to estimate (e.g., predict) future interference conditions, based on various parameters such as historical data, traffic load predictions, and/or machine learning-based prediction outputs, etc.

In some aspects, a UE can be configured to perform interference prediction based on a combination of one or more previous interference measurements by the UE (e.g., using one or more previous IMRs and/or historical data associated with one or more previous IMRs) and/or one or more previous interference predictions by the UE (e.g., interference predictions determined during one or more previous interference prediction resources or time allocations from the network entity to the UE). Different configurations of the type, periodicity, number, and patterns of the IMRs used by the UE to obtain interference measurements, and the time separation between the interference measurement and prediction resources allocated for the UE, can correspond to different performance levels (e.g., accuracy and/or confidence) of the corresponding interference prediction by the UE.

In one illustrative example, a network entity can configure a UE with IMRs and/or interference prediction resources for interference prediction, where the interference measurement resources are configured based on the one or more IMR configurations and/or capabilities reported by the UE to the network entity. For instance, the UE can report interference prediction recommendations (e.g., a recommended or requested configuration of measurement and prediction resources for the UE) that can be used by the UE to meet configured (e.g., target) interference prediction performance and/or confidence level thresholds. The UE can generate and report the interference prediction recommendations or configurations based on the UE interference measurement and prediction capabilities. In some aspects, the UE can transmit to the network entity information indicative of the UE interference measurement and prediction capabilities, and the network entity can determine and configure interference measurement and prediction resources for the UE based on analyzing (e.g., by the network entity) the reported UE interference measurement and prediction capabilities.

In some examples, the UE can be configured to report a recommended or requested configuration of interference measurement and prediction resources and/or interference prediction capability information of the UE, corresponding to various thresholds on the separation between the interference prediction resources and the interference measurement resources. For instance, the UE can report resource configuration recommendation information and/or interference prediction performance information corresponding to different time values of the separation (e.g., in ms, number of slots, etc.) between successive IMRs and interference prediction resources. In some cases, the UE interference prediction performance information can be indicative of a mean square error (MSE) or various other accuracy measures of the UE interference prediction. In some examples, the UE interference prediction performance information can be indicative of a level of confidence in the UE interference prediction.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

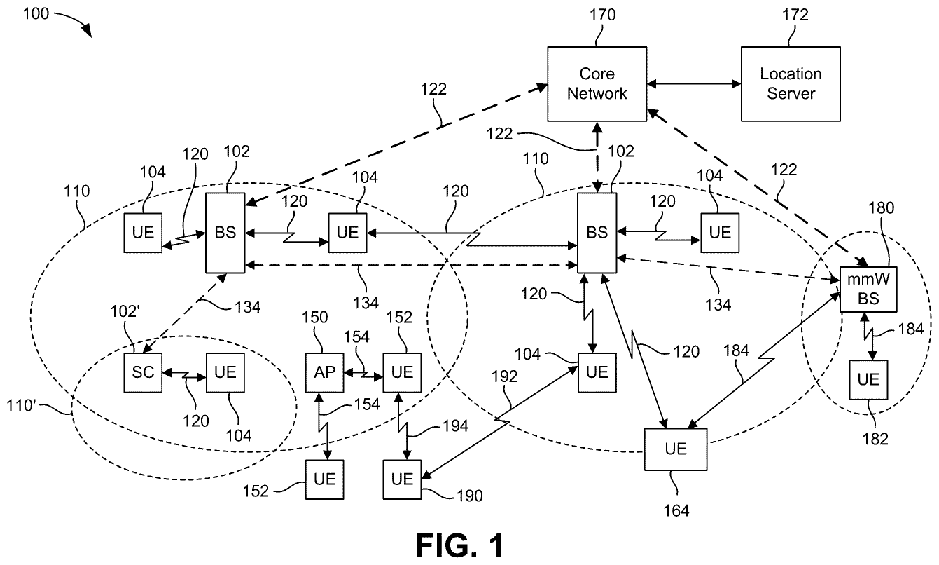

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

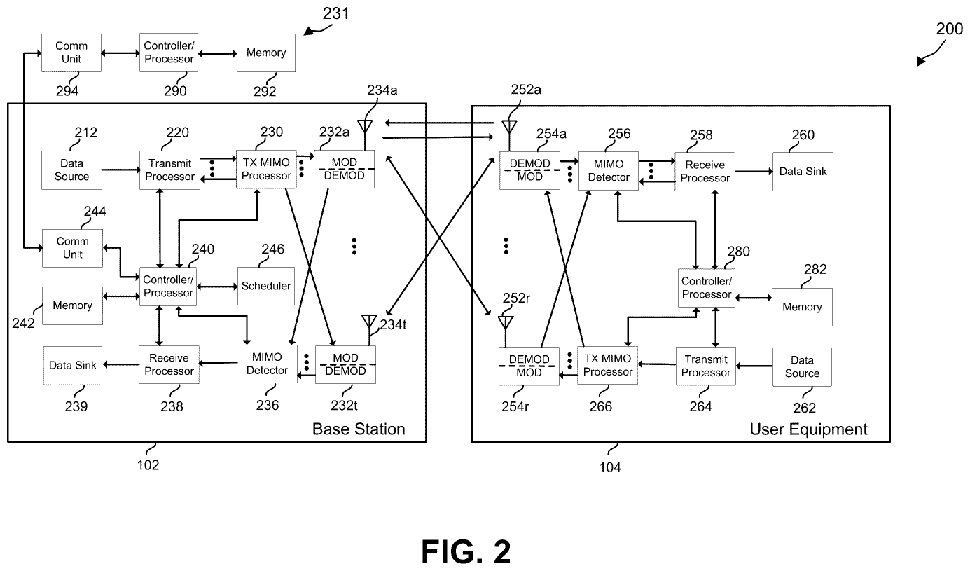

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations May be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

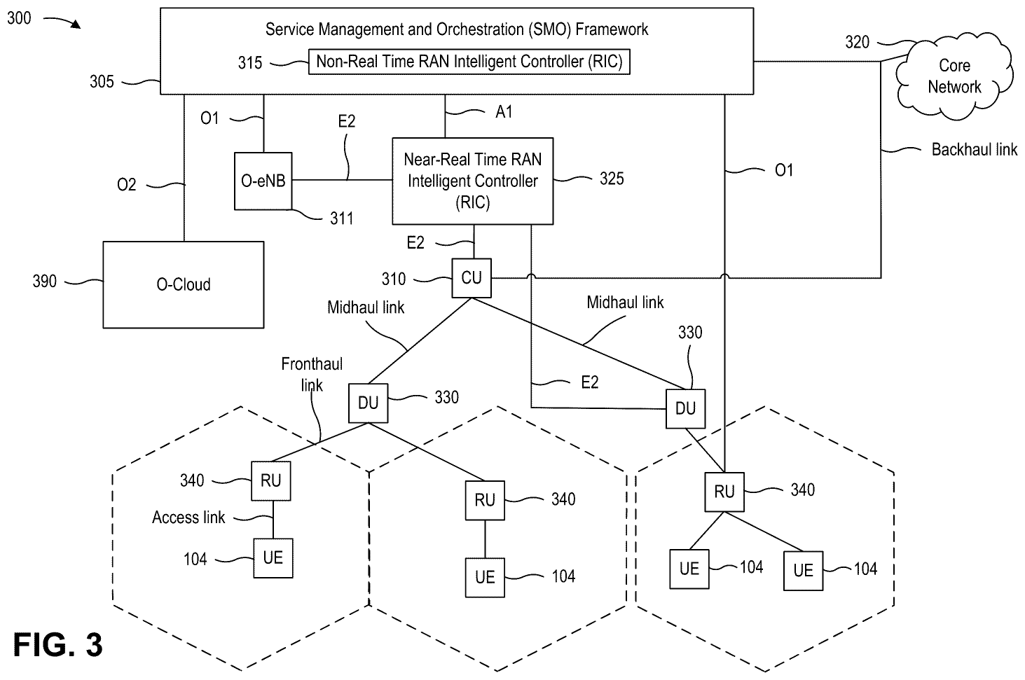

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

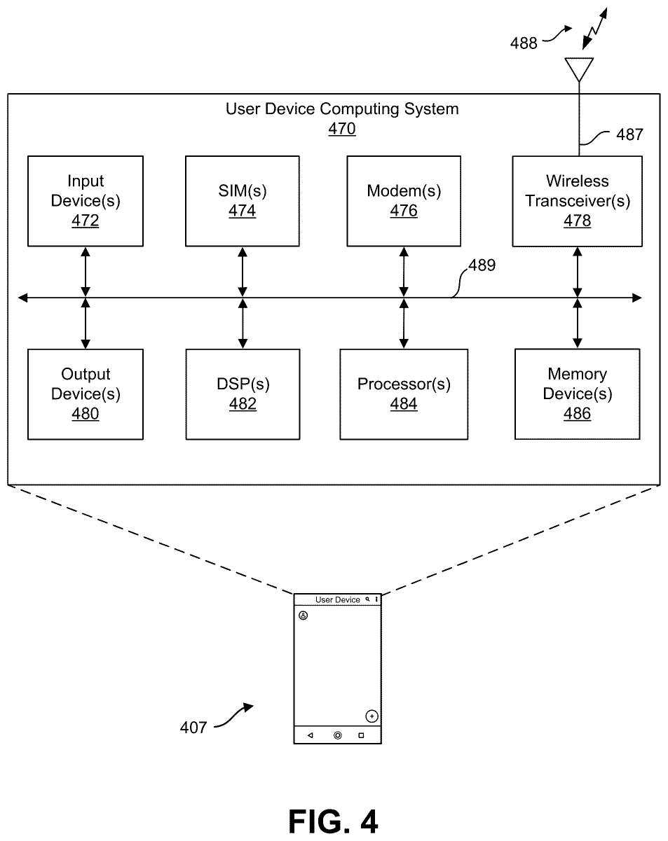

FIG. 4 illustrates an example of a computing system 470 of a wireless device 407. The wireless device 407 may include a client device such as a UE (e.g., UE 104, UE 152, UE 190) or other type of device (e.g., a station (STA) configured for communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

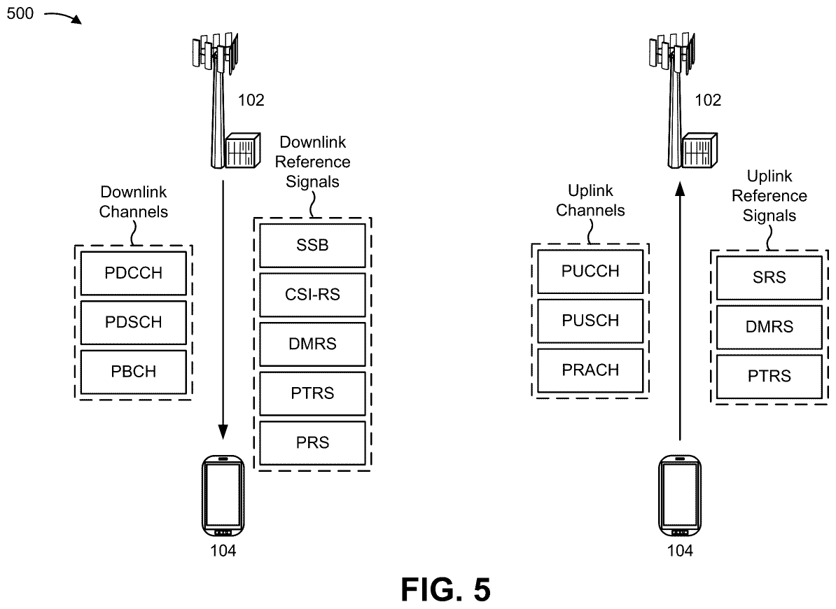

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

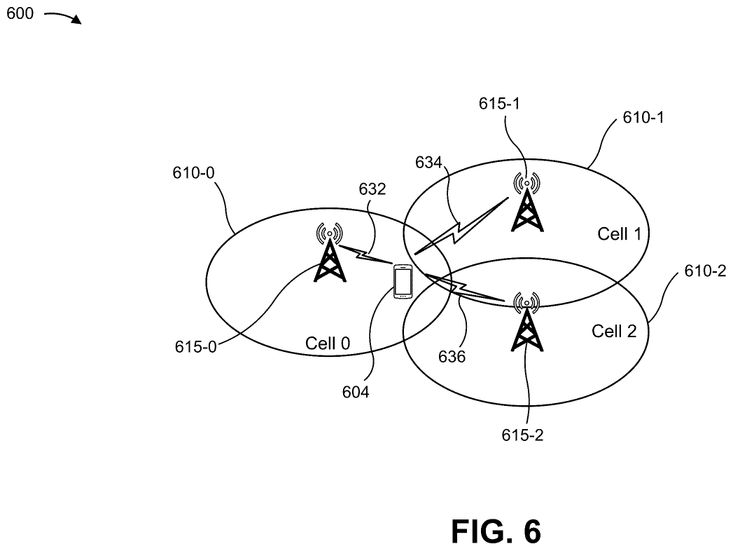

As noted previously, the systems and techniques described herein can be used to provide interference measurement resource (IMR) capability and/or configuration reporting information corresponding to a UE and/or interference prediction performed by the UE. Various types of interference may occur in a wireless communication network. For instance, FIG. 6 is a diagram illustrating an example of a configuration of a wireless communication network 600 where interference may occur, in accordance with some examples. The wireless communication network 600 can include a plurality of cells, including a Cell 0 (e.g., cell 610-0), a Cell 1 (e.g., cell 610-1), and a Cell 2 (e.g., cell 610-2), etc. Each cell of the plurality of cells can include one or more network entities, such as a base station, gNB, etc. For example, cell 610-0 includes a network entity 615-0, cell 610-1 includes a network entity 615-1, cell 610-2 includes a network entity 615-2, etc.

In some aspects, the wireless communication network 600 of FIG. 6 can be the same as or similar to a wireless communication network 170 or other wireless communication network of FIG. 1. In some examples, the plurality of cells 610-0, 610-1, 610-2 of FIG. 6 can be the same as or similar to one or more of the cells or geographic coverage areas 110 or 110′ of FIG. 1. In some cases, the one or more network entities 615-0, 615-1, 615-2 may be the same as or similar to the base station 102 and/or mmW base station 180 of FIG. 1, the base station 102 of FIG. 2, the network entity 102 of FIG. 5, etc. A UE 604 can be the same as or similar to one or more of the UEs of FIG. 1, the UE 104 of FIG. 2, the UEs 104 of FIG. 3, the UE 407 of FIG. 4, the UE 104 of FIG. 5, etc.

A UE located within a particular cell (e.g., UE 604 located within cell 610-0 of FIG. 6) may experience inter-cell interference based on receiving wireless signals from multiple cells (e.g., from respective network entities located within multiple cells). For instance, inter-cell interference can be associated with signals from neighboring cells that interfere with the signal within a current cell of a UE. In examples where UE 604 is within cell 610-0, inter-cell interference may correspond to interference between the signal 632 (e.g., between Cell 0 base station 615-0 and UE 604) and one or more of the signal 634 (e.g., associated with Cell 1 and the Cell 1 base station 615-1) and/or the signal 636 (e.g., associated with Cell 2 and the Cell 2 base station 615-2).

In some cases, inter-cell interference can occur more frequently towards the respective edges of each cell of the plurality of cells within the wireless communication network 600, where the signal from the serving cell is relatively weaker. For instance, towards the edge of the serving Cell 0 of FIG. 6, the signal 632 received by the UE 604 from the Cell 0 base station 615-0 is relatively weaker. Towards the edge of the serving Cell 0, the interfering signals 634 and 636 (e.g., from the Cell 1 base station 615-1 and the Cell 2 base station 615-2, respectively) are relatively stronger, and inter-cell interference may be observed by UE 604 with a greater magnitude and/or with a greater probability, etc. For instance, inter-cell interference can be based on frequency reuse, where a cellular network (e.g., wireless communication network 600) utilizes the same frequency bands across different cells (e.g., cell 610-0, 610-1, 610-2, etc.) to improve spectral efficiency. In examples where neighboring cells transmit on the same frequency or frequencies, a UE towards the edge of a serving cell may experience inter-cell interference from the neighboring cells transmitting on the same frequency. Higher density deployments of base stations, cells, and/or other network entities may additionally be associated with increased occurrence of inter-cell interference, along with various other factors such as irregular cell geometry or layouts, etc.

Inter-cell interference (e.g., among various other types of interference that may be observed by a UE such as UE 604) can correspond to reduced signal quality or a degraded (e.g., lower) signal-to-interference-plus-noise ratio (SINR), which may reduce the data rate for UE 604 and/or may increase the error rate for wireless communications to or from the UE 604. Inter-cell interference can, in some examples, be associated with a reduction in overall network throughput (e.g., reduced throughput for the wireless communication network 600), based on multiple UEs experiencing inter-cell interference at the same or similar time(s).

In some techniques for inter-cell interference mitigation or reduction, inter-cell interference coordination (ICIC) may be utilized to manage interference in a wireless communication network (e.g., such as wireless communication network 600). In ICIC, neighboring cells such as cells 610-0, 610-1, and 610-2 can be configured to coordinate resource allocation to reduce or minimize inter-cell interference, including for users and UEs located near or towards the edge of a respective one of the cells. In some aspects, beamforming can be used to focus the transmitted signal energy towards an intended UE, which may reduce the transmitted signal strength towards non-intended UEs (e.g., such as UEs within different and/or neighboring cells, etc.). In some cases, dynamic frequency allocation can be performed to adapt the frequency allocation(s) within different cells and/or for different UEs based on measured interference information.

Interference variation can occur when the interference associated with the uplink and/or downlink transmissions of a particular UE and/or other network entity (e.g., base station, gNB, etc.) changes over time. Interference variation can reduce the performance of a wireless communication network. For instance, interference measurements can be determined by a UE and subsequently reported (e.g., transmitted) from the UE to a base station. The base station can subsequently utilize the interference measurements received from the UE to determine and/or perform scheduling for the UE, where the upcoming scheduling for the UE is based at least in part on the UE's interference measurements. UE scheduling performed based on the last measured interference for a UE can be referred to as sample and hold.

Using sample and hold to serve a UE can reduce the performance of the wireless communication network (e.g., can decrease throughput, increase latency, etc.). For instance, sample and hold is associated with a time delay between the UE first determining the interference measurements and later receiving (e.g., from the base station) scheduling based on the UE's last reported interference measurements. The delay associated with serving a UE using sample and hold can cause a mismatch between the actual interference at a UE and the last reported interference used by the base station to perform scheduling for the UE. The mismatched or different interference measurements between the UE and the base station can correspond to the reduced wireless network performance noted above. In some cases, the interference mismatch may be associated with an increased interference variation and/or relatively rapid interference variation (e.g., interference changing over a shorter period of time than the delay between the UE interference measurement report and the corresponding scheduling performed by the base station).

In some examples, interference prediction can be performed by a UE and/or by a base station to reduce the delay between the determination of interference and the implementation of UE scheduling based on the determined interference. For instance, a base station can perform UE scheduling based on an interference prediction for the UE (e.g., one or more predicted interference measurements for the UE). In some cases, interference prediction can be based on a predicted interference covariance matrix and/or a predicted interference power. The predicted interference covariance matrix and/or predicted interference power can be determined using one or more artificial intelligence (AI) and/or machine learning (ML) networks. For example, interference prediction can be a highly non-linear task, as various configuration parameters at multiple different network locations (e.g., neighboring cells, etc.) can have an impact on the temporal, frequency, and/or spatial correlation of the inter-cell interference observed at a particular UE. For instance, the inter-cell interference measured for a particular UE can vary with the configuration of scheduling behavior for each respective cell of a group of neighboring cells (e.g., type of scheduler, such as proportional fair, round robin, etc.; scheduling granularity, such as mini-slot, slot, multi-slot, etc.). The inter-cell interference measured for a particular UE may additionally vary based on configuration parameters such as the number of active UEs, the traffic type(s) at the neighboring cells, loading and/or resource utilization (RU), beam management, etc. In some aspects, interference variations associated with a particular UE may further be based on channel variations (e.g., between interfering cells and the UE).

As noted previously, in some aspects, interference prediction can be performed using one or more artificial intelligence (AI) and/or machine learning (ML) networks, which may be configured to learn the interference variation patterns from previous interference measurement resources (IMRs) and/or previous interference prediction resources allocated for a particular UE.

In some aspects, an IMR can be a physical or virtual element used to measure real-time interference levels in a wireless communication network. For instance, in a cellular communication network, configured subcarriers, symbols, and/or resource elements (REs) can be utilized to measure interference as an interference-plus-noise ratio (INR) value, a signal-to-interference-plus-noise ratio (SINR) value, etc. An interference prediction resource can be allocated or configured for the UE as a time slot or other period of time during which the UE can perform interference prediction to estimate (e.g., predict) future interference conditions, based on various parameters such as historical data, traffic load predictions, and/or machine learning-based prediction outputs, etc. In some cases, an interference prediction resource can refer to a configured period of time for performing interference prediction by a UE, without the transmission of a physical signal or use of the network resources.

In some cases, a UE can be configured to perform interference prediction based on a combination of one or more previous interference measurements by the UE (e.g., using one or more previous IMRs and/or historical data associated with one or more previous IMRs) and/or one or more previous interference predictions by the UE (e.g., interference predictions determined during one or more previous interference prediction resources or time allocations from the network entity to the UE). Different configurations of the type, periodicity, number, and patterns of the IMRs used by the UE to obtain interference measurements, and the time separation between the interference measurement and prediction resources allocated for the UE, can correspond to different performance levels (e.g., accuracy and/or confidence) of the corresponding interference prediction by the UE. In some aspects, during the allocated or corresponding time for an interference prediction resource associated with the UE, the UE can perform interference prediction indicative of a predicted or estimated interference at a future time that is later than (e.g., after) the current interference prediction resource time.

In some cases, an interference prediction determined by and/or for a particular UE can be indicative of the interference (e.g., interference values, interference variations, etc.) on future resources scheduled for the UE. In some cases, the interference prediction can be utilized by the network and/or a network entity thereof to determined updated scheduling for serving the UE based on the predicted interference on the future resources, where the updated scheduling based on the predicted interference can be used to increase the network's throughput and/or latency.

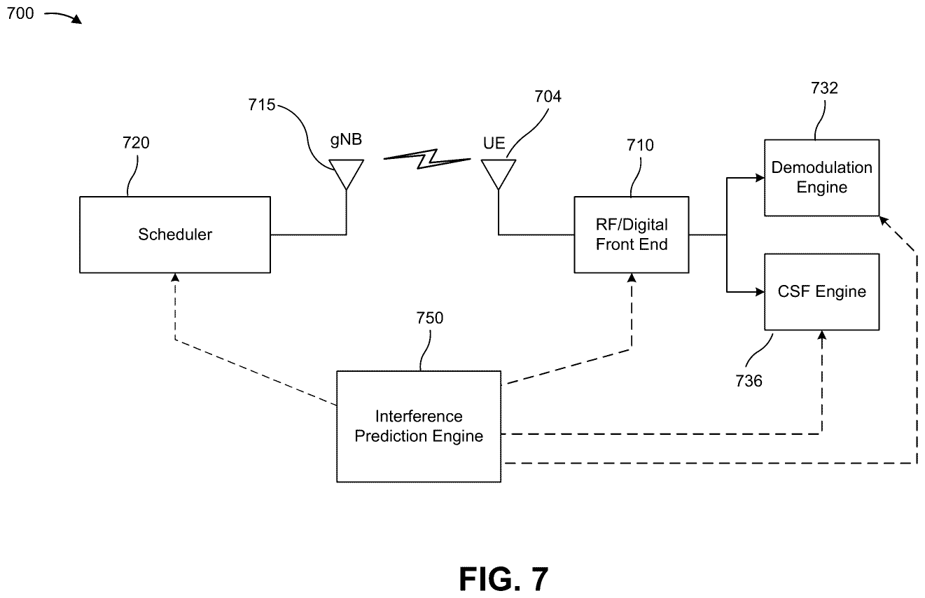

For example, FIG. 7 is a diagram illustrating an example of a wireless communication system 700 that can be configured to utilized interference predictions and/or interference prediction information determined by an interference prediction engine 750. In some aspects, the interference prediction engine 750 can be used to determine one or more interference predictions corresponding to a particular UE or UEs, at one or more future times. In some examples, the interference prediction engine 750 can be implemented by and/or included in a network entity such as a base station, gNB, etc. For instance, in some cases the interference prediction engine 750 can be included in and/or implemented by the gNB 715 and/or the UE 704. In some cases, the interference prediction engine 750 can be included in the wireless communication network 700 and may be implemented external to the gNB 715 and/or the UE 704. In some aspects, the gNB 715 can be the same as or similar to one or more of the network entities 615-0, 615-1, 615-2 of FIG. 6. In some examples, the UE 704 can be the same as or similar to the UE 604 of FIG. 6.

In one illustrative example, the wireless communication system 700 can include the UE 704, the gNB 715, the interference prediction engine 750, a scheduler 720, an RF/digital front end 710, a demodulation engine 732, and a Channel State Feedback (CSF) engine.

In some aspects, the network scheduler 720 can be configured to generate scheduling decisions associated with wireless communications between gNB 715 and UE 704, where the scheduler 720 makes the scheduling decisions based on predicted interference (e.g., at the UE 704 and/or for communications between UE 704 and gNB 715) determined by the interference prediction engine 750. For instance, the scheduler 720 can be implemented as a gNB-side network entity, and can utilize the predicted interference for UE 704 to determined improved scheduling decisions for transmissions from gNB 715 to UE 704. For instance, the scheduler 720 can use the predicted interference information from interference prediction engine 750 to exclude from resource allocation a subset of resources that are associated with a relatively high interference indication within the predicted interference information. In some examples, the scheduler 720 can use the predicted interference information to adjust one or more of a modulation coding scheme (MCS) and/or rank for communications between the UE 704 and the gNB 715. Increasing the MCS and/or rank can correspond to increasing the rate. In some aspects, scheduler 720 may be unable to increase the MCS and rank for the UE 704, based on increased MCS or rank corresponding to a better SNR (e.g., lower interference power). In some cases, the interference prediction information can be used to activate and/or deactivate one or more additional Rx blocks associated with one or more of UE 704 and/or RF front end 710 (e.g., front-end linearization, additional filters, etc.).

In some aspects, interference prediction information determined at the gNB 715 or UE 704 (e.g., using interference prediction engine 750, etc.) can be used to improve network performance at the UE-side. For instance, the interference prediction information can be utilized by an RF/digital front end 710 included in or associated with the UE 704 to perform automatic gain control (AGC) gain state prediction. AGC can be implemented by the UE 704 and/or RF front end 710 to adjust a gain value used by the RF front end 710, based on an incoming signal power value. In one illustrative example, a high interference prediction can correspond to a high incoming power at the UE 704 and/or RF front end 710 (e.g., a high incoming power at the future time associated with the interference prediction), and the interference prediction information from interference prediction engine 750 can be used to generate a relatively low gain configuration for the AGC gain state prediction. A low interference prediction can correspond to a low incoming power at the UE 704 and/or RF front end 710 (e.g., a low incoming power at the future time associated with the interference prediction), and the interference prediction information from interference prediction engine 750 can be used to generate a relatively high gain configuration for the AGC gain state prediction.

In another illustrative example, interference prediction information from the interference prediction engine 750 can be used by CSF engine 736 to implement Channel State Feedback (CSF) for the UE 704. For instance, UE 704 can utilize CSF engine 736 to determine channel state information (CSI) based on one or more received reference signals (e.g., such as one or more of the reference signals of FIG. 5, etc.) and provide the measured CSI as feedback to the gNB 715. Based on the CSI feedback from UE 704 and/or CSF engine 736, the gNB 715 can determine adapted transmission parameters (e.g., modulation schemes, beamforming vectors, power levels, etc.) to improve network throughput and/or reliability, etc.

In some aspects, CSF engine 736 can utilize the interference prediction information to perform interference measurement resource (IMR) overhead reduction. For instance, an interference prediction indicative of predicted interference at a future time t₁ can be used to reduce the number of IMRs that need to be allocated to perform a real-time interference measurement at t₁ (e.g., a smaller number of IMRs can be used to perform real-time interference measurement at time t₁, based on utilizing the earlier interference prediction for time t₁ in combination with the smaller number of IMRs to determine or the real-time measurement of interference at time t₁).

In some examples, CSF engine 736 can utilize the interference prediction information to perform CSI prediction and/or to determine a predicted CSI, where the CSI prediction and interference prediction correspond to the same future time(s). In some aspects, CSI measured at time to can be used to determine an interference prediction for time t₁, and the interference prediction for time t₁ can be used to determine a CSI prediction for the same future time t₁. In some cases, CSF engine 736 can use interference prediction information to perform CSI prediction and compression, and may additionally perform channel prediction based at least in part on the interference prediction information.

In another illustrative example, a demodulation engine 732 can be included in and/or associated with one or more of the RF front end 710 and/or the UE 704. The demodulation engine 704 can also be referred to as “demback.” In some aspects, the demodulation engine 732 can use the interference prediction information (e.g., from interference prediction engine 750) and/or associated smoothing thereof to implement advanced receivers. For instance, the demodulation engine 732 can select a receiver algorithm for use by the UE 704 based on the predicted interference information (e.g., predicted SINR, etc.) determined by interference prediction engine 750. In some examples, the demodulation engine 732 can be configured to implement a selected receiver algorithm from at least maximum likelihood (ML) estimation or minimum mean square error (MMSE) estimation. In some cases, MMSE estimation can be used to implement a less computationally complex receiver algorithm with relatively lower performance, and ML estimation can be used to implement a more computationally complex receiver algorithm with relatively higher performance.

In some cases, the performance (e.g., accuracy) of MMSE estimation can be the same as or similar to the performance (e.g., accuracy) of ML estimation when the interference covariance matrix is near diagonal. In some examples, the demodulation engine 732 can utilize interference prediction information to select an MMSE estimation receiver algorithm based on the interference prediction information being indicative of an interference covariance matrix that is near diagonal. The demodulation engine 732 can select an ML estimation receiver algorithm based on the interference prediction information being indicative of an interference covariance matrix that is not near diagonal.

In some examples, an interference prediction engine (e.g., implemented at a UE 704, implemented at a network entity 715, or both, etc.) can be configured to perform interference prediction based on a combination of one or more previous interference measurements (e.g., using one or more previous IMRs and/or historical data associated with one or more previous IMRs) and/or one or more previous interference predictions (e.g., interference predictions determined during one or more previous interference prediction resources or time allocations for interference prediction). Different configurations of the type, periodicity, number, and patterns of the IMRs used by the interference prediction engine to obtain interference measurements can correspond to different interference prediction accuracy and/or confidence levels (e.g., where one or more past interference measurements using the configured IMRs are used to determine the interference prediction).

For example, a UE configured to perform interference prediction (e.g., a UE configured to implement the interference prediction engine 750 of FIG. 7, etc.) may be associated with an interference prediction accuracy of within ±5 dB error around the correct interference value with 90% confidence when Channel State Information-Reference Signals (CSI-RS) is used as the IMRs.

The same UE may be associated with a different (e.g., greater or lesser) interference prediction accuracy when a different type of IMRs are used. For instance, the same UE may be associated with a ±3 dB error around the correct interference value with 90% confidence when Channel State Information-Interference Measurement (CSI-IM) is used as the IMRs

In some aspects, the systems and techniques described herein can be used to determine interference prediction information for wireless communications between a UE and a network entity. The interference prediction information can be determined based on one or more previous interference measurements determined for wireless communications between the UE and the network entity. For instance, the interference prediction information can be based on previous measurements associated with one or more IMRs configured by the network entity (e.g., base station, gNB, etc.) associated with the UE. In one illustrative example, the interference prediction information can comprise a predicted interference covariance matrix (e.g., also be referred to as an Rₙₙ matrix) and/or a predicted interference power (e.g., trace (Rₙₙ)), determined based on one or more previous interference measurements of configured IMRs.

As noted above, the accuracy and/or confidence level of an interference prediction from past interference measurements can be based on parameters such as the type, periodicity, number, and/or patterns, etc., of the IMRs associated with the past interference measurements. In some aspects, the accuracy and/or confidence level of an interference prediction can further be based on the time separation between the interference measurement resources and the interference prediction resources. For example, when a larger time separation is used between IMRs and interference prediction resources, the interference prediction accuracy can be relatively low based on using relatively old IMR measurements to generate the interference prediction. When a smaller time separation is used between IMRs and interference prediction resources, the interference prediction accuracy can be relatively high based on using relatively recent IMR measurements to generate the interference prediction. For instance, a lower time separation between interference measurement and prediction resources can be associated with a higher accuracy of the interference prediction, based on a greater correlation between interference measurement and prediction resources with a lower time separation.

In one illustrative example, a UE can be configured to indicate (e.g., to a network entity, such as a base station, gNB, etc.) capability information indicative of the UE's capability to perform interference prediction within one or more configured interference prediction performance thresholds and/or one or more configured interference prediction confidence thresholds. For instance, the UE can be configured (e.g., pre-configured, configured based on signaling from a network entity, etc.) with an interference prediction performance threshold value corresponding to a minimum target accuracy or performance in the error (e.g., MSE, etc.) of the interference predictions determined by the UE. For example, an interference prediction with a ±3 dB error from the correct interference value can be within a configured interference prediction performance threshold of ±5 dB error. In another example, an interference prediction with a ±3 dB error from the correct interference value is not within a configured interference prediction performance threshold of ±1 dB error.

In some examples, the UE can implement interference prediction using one or more machine learning networks and/or based on one or more machine learning-based techniques for interference prediction. In some aspects, machine learning interference prediction can be associated with a corresponding confidence level (e.g., a percentage, etc.) for each respective interference value that is predicted by the machine learning interference prediction network. In some cases, a UE can be configured (e.g., pre-configured, configured based on signaling from a network entity, etc.) with an interference prediction confidence threshold corresponding to a minimum or target confidence level for the interference prediction determined by the machine learning interference prediction network implemented by the UE. For instance, an interference prediction with a 90% confidence level is within a configured interference prediction confidence threshold of 80%, but is outside of a configured interference prediction confidence threshold of 95%. In another example, an interference prediction with an 80% confidence level is within a configured interference prediction confidence threshold of 60% but is no within a configured interference prediction confidence level of 90% or 95%, etc.

In one illustrative example, a network entity can configure a UE with IMRs and/or interference prediction resources for interference prediction, where the interference measurement resources are configured based on the one or more IMR configurations and/or capabilities reported by the UE to the network entity. For instance, the UE can report interference prediction recommendations (e.g., a recommended or requested configuration of measurement and prediction resources for the UE) that can be used by the UE to meet configured (e.g., target) interference prediction performance and/or confidence level thresholds. The UE can generate and report the interference prediction recommendations or configurations based on the UE interference measurement and prediction capabilities. In some aspects, the UE can transmit to the network entity information indicative of the UE interference measurement and prediction capabilities, and the network entity can determine and configure interference measurement and prediction resources for the UE based on analyzing (e.g., by the network entity) the reported UE interference measurement and prediction capabilities.

In some aspects, an “interference prediction configuration” and/or “IMR capabilities” associated with a UE can be used interchangeably. For instance, a UE can transmit (e.g., to a network entity) information indicative of one or more interference prediction configurations for the UE to meet the configured interference prediction performance and/or confidence thresholds associated with communications between the UE and the network entity.

In some cases, the interference prediction configuration information can indicate whether or not a UE can utilize a current or most recent configuration of IMRs and interference prediction resources (e.g., from the network entity) to meet a configured interference prediction performance (e.g., accuracy or MSE, etc.) threshold, an interference prediction confidence threshold, or both.

In some aspects, the interference prediction configuration information can be indicative of a maximum interference prediction performance level or value (e.g., accuracy, MSE, etc.) associated with interference predictions determined by the UE when utilizing the current or most recent configuration of IMRs and interference prediction resources from the network entity.

In some examples, the interference prediction configuration information can be indicative of an IMR and interference prediction resource configuration that can be utilized by the UE to perform interference prediction within the configured performance (e.g., accuracy or MSE, etc.) threshold and within the configured confidence threshold.

In one illustrative example, the UE can report a recommended configuration of IMRs and interference prediction resources to be scheduled by a network entity for future use by the UE to perform interference measurements and interference predictions based on the interference measurements. For instance, the UE-reported configuration information for interference prediction can be indicative of one or more types of IMRs that can be used to obtain (e.g., by the UE) interference measurements and perform interference prediction within the configured accuracy threshold and/or within the configured confidence threshold.

In some aspects, interference measurement resources (IMRs) can be configured as one or more of a Channel State Information-Reference Signal (CSI-RS), Channel State Information-Interference Measurement (CSI-IM), physical downlink shared channel-demodulation reference signal (PDSCH-DMRS), PDSCH-null tones, etc. Different types of IMRs (e.g., CSI-RS, CSI-IM, PDSCH-DMRS, PDSCH-null tones, etc.) can correspond to different interference estimation techniques, which can be associated with different respective interference measurement accuracies. For instance, the accuracy of an interference measurement determined using CSI-RS as the IMRs can be different than the accuracy of an interference measurement determined using CSI-IM as the IMRs, which can be different than the accuracy of an interference measurement determined using PDSCH-DMRS as the IMRs, which can be different than the accuracy of an interference measurement determined using PDSCH-null tones as the IMRs, etc. As noted previously, the accuracy of the interference measurement determined by a UE can correspond to the accuracy of the interference prediction performed by the UE, as the interference prediction may be based on earlier interference measurements.

In another example, the UE interference prediction configuration and/or capability information can be indicative of a number of interference measurements. For instance, as the UE measures interference on a greater number of IMRs before performing an interference prediction, the UE can determine interference prediction information with a greater performance (e.g., greater accuracy or MSE, and a greater confidence level or percentage). In some cases, the UE interference prediction configuration and/or capability information can be indicative of a quantity of time slots into the future (e.g., offset from the current time slot of the UE report to the network entity, etc.) within which the UE can perform interference prediction without falling below either of the configured accuracy/MSE threshold value or the configured confidence threshold value for interference prediction performance. For interference predictions corresponding to future times beyond the indicated quantity of time slots into the future, the UE prediction performance can be below one or both of the configured accuracy/MSE threshold value and the configured confidence threshold value.

In another example, the UE interference prediction configuration and/or capability information can be indicative of a reference signal periodicity used as a measurement resource (e.g., IMR). For instance, as the periodicity of the reference signals used in measuring the interference (e.g., CSI-RS, CSI-IM, PDSCH-DMRS, PDSCH-null tones, etc.) decreases, the UE interference prediction performance can improve for the predicted interference values determined for interference on future resources. In some cases, an increased periodicity of the reference signals used for IMRs measurement can be associated with increased overhead for wireless communications on the network and/or between the UE and associated network entity. In one illustrative example, the UE can generate and transmit the interference prediction configuration and/or capability information to a network entity (e.g., gNB, base station, etc.), where the interference prediction configuration or capability information is indicative of a periodicity of measurement resources determined by the UE based on the interference prediction performance-signaling overhead tradeoff. For example, the UE can choose a minimum periodicity of IMRs that corresponds to interference predictions by the UE that have a performance greater than or equal to the configured accuracy or MSE threshold value, the configured confidence threshold value, or both. In some cases, the UE can choose an IMR periodicity for interference measurement and prediction by the UE, where the periodicity indicated by the UE in the report to the network entity is smaller (e.g., shorter periodicity) than the minimum periodicity of IMRs that allows the UE to meet the configured accuracy/MSE threshold and the configured confidence level threshold.

As noted above, in some aspects, a UE can be configured to generate and transmit interference prediction configuration to a network entity, where the interference prediction configuration is indicative of one or more of a requested configuration of interference measurement and prediction resources scheduled for the UE (e.g., scheduled by the network entity receiving the transmission from the UE) and/or interference measurement and prediction capabilities of the UE. In one illustrative example, the requested configuration indicated by the UE and/or the interference measurement and prediction capabilities of the UE can be based on or compared to one or more configured thresholds of interference prediction accuracy (e.g., MSE, etc.) and interference prediction confidence level (e.g., confidence percentage, etc.).

In one illustrative example, a UE can be configured to report its interference prediction configuration request and/or capabilities to be indicative of one or more measurement resources (e.g., IMRs) type(s) that can be used by the UE to perform interference prediction within the configured threshold values of accuracy (e.g., MSE) and/or confidence. For example, the resource type (e.g., CSI-RS, CSI-IM, PDSCH-DMRS, PDSCH-null tones, etc.) used by the UE in measuring the interference covariance matrix Rₙₙ can correspond to the quality (e.g., accuracy and/or confidence) of the measured interference values determined by the UE. A higher quality (e.g., higher accuracy and/or higher confidence) interference measurement by the UE can correspond to a higher quality (e.g., higher accuracy and/or higher confidence) interference prediction by the UE, based on the higher quality interference measurement. A lower quality (e.g., lower accuracy and/or lower confidence) interference measurement by the UE can correspond to a lower quality (e.g., lower accuracy and/or lower confidence) interference prediction by the UE, based on the lower quality interference measurement.

For instance, an interference measurement determined based on CSI-IM reference signals used as the IMRs and/or an interference measurement determined based on null tones embedded within a scheduled resource block can be used for interference measurement based on determining the interference covariance matrix Rₙₙ based on:

$${\hat{R}}_{n n} = avg \{ y {y}^{H} \} \qquad Eq . ( 1 )$$

Here, y represents the received signal received by the UE (e.g., the UE reception of an IMR comprising a CSI-IM or null tones) and y^{H} represents a transpose or conjugate transpose of the matrix y representing the received IMR signal. For instance, the term y^{H} can be calculated by determining the transpose of matrix y, which is then conjugated to obtain y^{H}. In some aspects, in the downlink slots associated with a scheduled or allocated CSI-IM or null tones utilized as IMRs, the network entity does not transmit a physical signal to the UE (e.g., does not transmit data to the UE). The UE reception or received signal, y, during the downlink slots associated with the CSI-IM or null tone IMRs can be indicative of interference at the UE from signals that are not transmitted by the entity (e.g., in the example of inter-cell interference, the UE 604 of FIG. 6 reception or received signal, y, may correspond to the interference at the UE 604 from the neighboring cell signals 634 and/or 636. In this example, the signal y received by the UE can be an interference signal, and the interference covariance matrix can be determined using Eq. (1).

In another illustrative example, an interference measurement determined based on IMRs comprising a DMRS or CSI-RS reference signal can be obtained based on determining the interference covariance matrix as:

$${\hat{R}}_{n n} = a v g \{ ( y - \hat{H} x ) {( y - \hat{H} x )}^{H} \} \qquad Eq . ( 2 )$$

In Eq. (2), y represents the received IMRs or interference measurement resource signal at the UE; the term x represents a DMRS or CSI-RS sequence used for the IMRs (e.g., transmitted by the network entity and received by the UE); and Ĥ is a channel estimate value, which may be a DMRS-based, CSI-RS-based, or various other channel estimate value. For instance, the interference measurement of Eq. (2) can be determined as the expectation of the product of a first term y−Ĥx (e.g., indicative of the difference between the received signal y and the signal Ĥx that would be received with zero interference) with a second term comprising the conjugate transpose of the first term.

In another illustrative example, an interference measurement can be determined based on the covariance matrix of PDSCH data tones:

$${\hat{R}}_{n n} = {\hat{R}}_{y y} - \hat{H} {\hat{H}}^{H} \qquad Eq . ( 3 )$$

In Eq. (3), \hat{R}_{yy}=avg{yy^{H}} and is an Rx covariance matrix estimate (e.g., covariance estimate of the IMRs reception obtained or received by the UE). In some aspects, the Rx covariance matrix estimate \hat{R}_{yy} can be determined based on symbol or subband-wise averaging over data tones of the PDSCH data tones comprising the IMRs transmitted by the network entity and/or received by the UE for the interference measurement. In some aspects, the interference measurement and interference covariance matrix of Eq. (3) may not guarantee the positive definitiveness of Rₙₙ, and in some cases additional processing (e.g., such as regularization, etc.) may be performed by the UE to obtain the final interference measurement or interference covariance matrix for the IMRs.

In some aspects, a UE can be configured to report an interference prediction configuration request and/or capabilities information indicative of one or more thresholds on the separation (e.g., time separation or time offset) between interference prediction resources and IMRs scheduled and transmitted from the network entity to the UE. For instance, the UE can transmit or report the interference prediction configuration request and/or capabilities information to the same network entity that schedules and transmits the interference prediction resources and IMRs utilized by the UE for interference prediction and measurement. In some examples, the UE interference prediction reporting information can be indicative of resource configurations that can be used by the UE to meet or exceed the configured interference prediction performance thresholds (e.g., accuracy or MSE threshold value(s), confidence level threshold value(s), etc.).

In some examples, the UE can report a requested or recommended interference resource configuration (e.g., IMR configuration and/or interference prediction resource configuration) to the network entity indicative of a particular time separation value (e.g., in a number of ms or time slots of the network, etc.) between the interference prediction resources and the IMRs. For instance, interference prediction resources and IMRs configured and/or scheduled by the network entity with the requested time separation (e.g., the requested or recommended interference resource configuration reported by the UE to the network entity) can be used by the UE to perform interference measurement and prediction with an accuracy (e.g., interference prediction MSE or other accuracy value) and/or confidence level that is greater than or equal to respective configured accuracy threshold values and/or configured confidence level values for interference prediction at the UE.

In some aspects, a greater time separation between an interference prediction resource and earlier measurement resources (e.g., IMRs used for the interference prediction at the interference prediction resource time slot) can be associated with a lower accuracy of the interference prediction. For instance, greater interference variation can occur from the last-measured interference value(s) of the IMRs and the subsequent interference prediction resource, given a longer time separation between the IMRs and subsequent interference prediction resource (e.g., less correlation between the interference prediction and measurement resources).

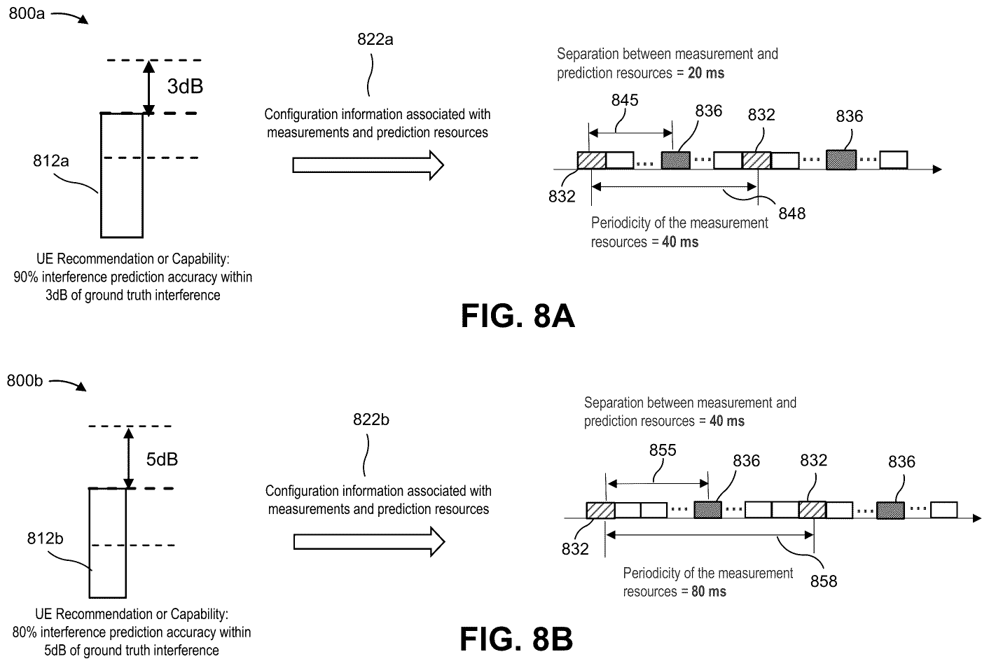

For instance, FIG. 8A is a diagram illustrating an example of an interference measurement and prediction resource configuration 800a associated with a first time separation 845a between interference measurement and prediction resources. FIG. 8B is a diagram illustrating an example of an interference measurement and prediction resource configuration 800b associated with a second time separation 855 between interference measurement and prediction resources, where the second time separation value 855 of FIG. 8B is longer (e.g., larger) than the first time separation value 845 of FIG. 8A.

In one illustrative example, the interference measurement and prediction resource configuration 800a of FIG. 8A can correspond to a time separation 845 of 20 ms between consecutive or adjacent IMRs 832 and interference prediction resources 836 (e.g., a first time separation value 845 equal to 20 ms). The interference measurement and prediction resource configuration 800b of FIG. 8B can correspond to a time separation 855 of 40 ms between consecutive or adjacent IMRs 832 and interference prediction resources 836 (e.g., a second time separation value 855 equal to 40 ms). In some aspects, the IMRs 832 of FIG. 8A and FIG. 8B can be the same as or similar to one another. In some cases, the interference prediction resources 836 of FIG. 8A and FIG. 8B can be the same as or similar to one another.

In some aspects, the time separation between interference measurement and prediction resources (e.g., time separation 845 and/or 855 of FIGS. 8A and 8B, respectively) can be different from a periodicity between consecutive IMRs 832 and/or can be different from a periodicity between consecutive interference prediction resources 836. For instance, the consecutive IMRs 832 of FIG. 8A can have a periodicity of measurement resources 848a equal to 40 ms (e.g., different from the 20 ms time separation 845 between the IMRs 832 and the interference prediction resources 836 of the resource configuration 800a of FIG. 8A). The consecutive IMRs 832 of FIG. 8B can have a periodicity of measurement resources 858 equal to 80 ms (e.g., different from the 40 ms time separation 855 between the IMRs 832 and the interference prediction resources 836 of the resource configuration 800b of FIG. 8B).

In one illustrative example, the longer time separation 855 between IMRs 832 and prediction resources 836 of FIG. 8B can be associated with a lower accuracy (e.g., larger MSE) associated with the interference prediction values determined by the UE at the interference prediction resources 836 of FIG. 8B. For instance, utilizing the 40 ms time separation 855 between the measurement and prediction resources of FIG. 8B (e.g., IMRs 832 and interference prediction resources 836 of FIG. 8B, a UE or other interference prediction engine may determine an interference measurement value that is within ±5 dB MSE of the ground truth interference value 812b corresponding to an interference prediction resource 836. In some aspects, the 40 ms time separation 855 between measurement and prediction resources, and the 80 ms periodicity 858 of the measurement resources (e.g., IMRs 832) can correspond to a UE interference prediction performance of 80% interference prediction accuracy (e.g., 80% confidence level) within 5 dB of the ground truth interference value 812b (e.g., within ±5 dB MSE accuracy).

The 20 ms time separation 845 between the measurement and prediction resources of FIG. 8A, and the 40 ms periodicity of the measurement resources (e.g., IMRs 832) of FIG. 8A, can correspond to improved UE interference prediction performance of 90% interference prediction accuracy (e.g., 90% confidence level) within 3 dB of the ground truth interference value 812a (e.g., within ±3 dB MSE accuracy).

In another illustrative example, a UE may obtain an interference prediction MSE of ±3 dB when configured (e.g., by the network entity) with prediction resources that are 50 ms away from the measurement resources (e.g., ±3 dB MSE interference prediction accuracy associated with a 50 ms time separation between the interference measurement and prediction resources scheduled for the UE by the network entity). The same UE may obtain a lower or reduced interference prediction performance that drops to an interference prediction MSE accuracy of ±5 dB when then the network entity configures IMRs and interference prediction resources that have a time separation of 100 ms.

In some aspects, a UE interference prediction accuracy and/or confidence level can be based on the frequency and/or the beam separation between the interference measurement and prediction resources. For instance, the UE interference prediction accuracy and/or confidence level can increase or decrease as the frequency and/or beam separation between IMRs and interference prediction resources increases or decreases, and vice versa.

In one illustrative example, the UE can be configured to transmit configuration information 822a or 822b indicative of interference measurement and prediction capabilities and/or performance values (e.g., relative to the configured MSE or accuracy threshold value, and/or relative to the configured confidence level threshold value, etc.) of interference prediction implemented at the UE. For instance, the configuration information 822a of FIG. 8A may indicate that to achieve interference prediction performance within configured threshold values of ±3 dB MSE accuracy with 90% confidence, the UE recommends or requests an interference resource configuration from the network entity with a 20 ms time separation 845 between IMRs 832 and interference prediction resources 836. In some cases, the configuration information 822a can be indicative of a UE recommendation or request for an interference resource configuration that additionally utilizes a 40 ms periodicity of the IMRs 832 scheduled by the network entity receiving the configuration information 822a.

In another example, the configuration information 822b of FIG. 8B can indicative that the UE may achieve interference prediction performance within configured threshold values of ±5 dB MSE accuracy with 80% confidence (E.g., different from the configured threshold values of the example of FIG. 8A) based on a UE request (e.g., to the network entity) for an interference resource configuration utilizing a 40 ms time separation 855 between IMRs 832 and interference prediction resources 836. In some cases, the configuration information 822b of FIG. 8B can be indicative of a UE recommendation or request for an interference resource configuration that additionally utilizes an 80 ms periodicity of the IMRs 832 scheduled by the network entity receiving the configuration information 822b.

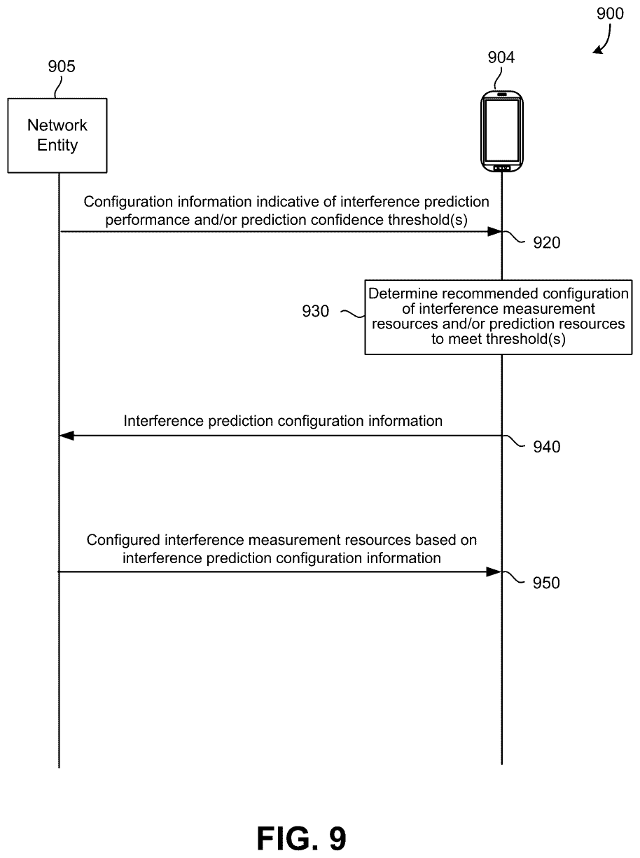

FIG. 9 is a signaling diagram corresponding to a process 900 of wireless communication and interference prediction configuration between a network entity 905 and a UE 904, in accordance with some examples. In one illustrative example, the UE 904 of FIG. 9 can be the same as or similar to one or more of the various UEs of any one or more of FIGS. 1-8, including UE 604 of FIG. 6, UE 704 of FIG. 7, etc. In some aspects, the network entity 905 of FIG. 9 may be a base station, gNB, etc. In some cases, the network entity 905 of FIG. 9 can be the same as or similar to one or more of the various network entities of any one or more of FIGS. 1-8, including the base stations 615-0, 615-1, and/or 615-21 of FIG. 6, the gNB 715 of FIG. 7, etc.

In some examples, the network entity 905 can be associated with a serving cell for the UE 904 (e.g., the network entity 905 can be the same as the serving base station 615-0 of Cell 0 of FIG. 6 and the UE 904 can be the same as the UE 604 within Cell 0 of FIG. 6, etc.). In one illustrative example, the network entity 905 can transmit to the UE 904 configuration information 920 indicative of one or more interference prediction performance threshold values and/or one or more interference prediction confidence threshold values. For instance, the configuration information 920 can be used to configure the UE 904 with threshold values (e.g., determined and/or requested by the network entity 905) for one or more upcoming interference prediction resources or time windows that will be scheduled by the network entity 905 for the UE 904 to determine an interference prediction.

In some aspects, the configuration information 920 can be indicative of configured accuracy value thresholds or MSE threshold values on the maximum difference configured by the network entity 905 on the difference between a predicted interference value determined by the UE 904 and the actual interference measurement observed by the UE 904 for the same time slot(s) associated with the interference prediction.

At block 930, the UE 904 can determine a recommended or requested interference resource configuration corresponding to upcoming interference measurement resources (e.g. IMRs) and/or upcoming interference prediction resources that will be configured or scheduled by the network entity 905 for interference measurement and prediction that will be performed by the UE 904. For instance, the recommended or requested configuration of interference measurement and prediction resources 930 can be indicative of one or more of a type of reference signal for the IMRs (e.g., CSI-RS, CSI-IM, PDSCH-DMRS, PDSCH-null tones, etc.), a number of IMRs, a number of interference prediction resources, a number of IMRs used for the interference prediction at each interference prediction resource, a periodicity between consecutive IMRs, a periodicity between consecutive interference prediction resources, a pattern of IMRs and interference prediction resources scheduled by the network entity for the UE, and/or a time separation value (e.g., in a number of ms, in a number of time slots, etc.) between the IMRs and the interference prediction resources used by the UE for interference measurement and prediction, etc.

In some examples, the UE 904 can determine one or more recommended or requested configurations of IMRs and interference prediction resources to be scheduled by the network entity 905, based on analyzing the UE 904 interference measurement and prediction capabilities against the configured interference prediction performance and confidence threshold values 920 indicated by the network entity 905.

For instance, in one illustrative example, the network entity 905 can indicate configured interference prediction performance thresholds 920 that the UE 904 is required to meet, and the UE 904 can determine at block 930 one or more IMR and interference prediction resource configurations that correspond to interference prediction performance by the UE 904 that is greater than or equal to the respective configured performance threshold values 920 indicated by the network entity 905.

In another illustrative example, the network entity 905 can indicate configured interference prediction performance thresholds 920 that the UE 904 may attempt to meet, without the UE 904 being required to achieve interference prediction performance that is greater than or equal to the respective configured performance threshold values 920. For instance, the recommended configuration for IMRs and interference prediction resources determined by the UE at block 930 can comprise a best-effort recommendation or configuration of IMRs and interference prediction resources, that achieves interference prediction performance that is near the configured thresholds and/or within a configured maximum distance or offset from the configured threshold values (e.g., in examples where the UE performance (e.g., MSE prediction accuracy value and/or prediction confidence level is not within (e.g., is below) one or both of the configured interference prediction performance threshold values 930).

At block 940, the UE 904 can transmit interference prediction configuration information to the network entity 905, where the transmitted interference prediction configuration information is based on and/or indicative of the one or more recommended or requested configurations of IMRs and interference prediction resources determined by the UE 904 at block 930. In some aspects, the interference prediction configuration information 940 transmitted from the UE 904 to the network entity 905 can include each interference resource configuration of the one or more interference resource configurations determined by the UE 904 at block 930.

At block 950, the network entity 905 can configure, schedule, and/or allocate a plurality of IMRs and/or interference prediction resources for the UE 904, where the configured plurality of IMRs and interference prediction resources of block 950 are provided by the network entity 905 based on the interference prediction configuration information 940 transmitted by the UE 904 (e.g., and received by the network entity 905 from the UE 904).

Based on the configured IMRs and/or interference prediction resources scheduled for the UE 904 by the network entity 905 at block 950, the UE 904 can subsequently determine one or more measured interference values for each respective IMR of the one or more IMRs scheduled by the network entity 905. For instance, based on the type of reference signal used for the IMRs, the UE 904 can determine the one or more interference measurements for each IMR utilizing various ones of Eqs. (1)-(3), etc.

Based on the configured number of IMRs per interference prediction resource, the UE 904 can subsequently use the scheduled time period or time slots corresponding to an interference prediction resource to determine interference prediction information, where the determined interference prediction information is based at least in part on the one or more measured interference values using the earlier IMRs.

In some aspects, the interference prediction configuration information 940 reported by the UE 904 (e.g., transmitted by the UE 904 to the network entity 905) can be reported statically. For instance, the UE 904 can perform static reporting of the UE interference prediction configuration information 940 based on transmitting, to the network entity 905, one or more radio resource control (RRC) messages indicative of the determined interference prediction configuration information 940 associated with the UE 904.

In another illustrative example, the UE 904 can perform semi-static reporting of the interference prediction configuration information 940, for example based on transmitting, to the network entity 905, one or more Media Access Control (MAC)-Control Elements (MAC-CE) indicative of the determined interference prediction configuration information 940 for the UE 904.

In some aspects, the UE 904 can perform dynamic reporting of the interference prediction configuration information 940, for example based on transmitting, to the network entity 905, Uplink Control Information (UCI) indicative of the determined interference prediction configuration information 940 for the UE 904.

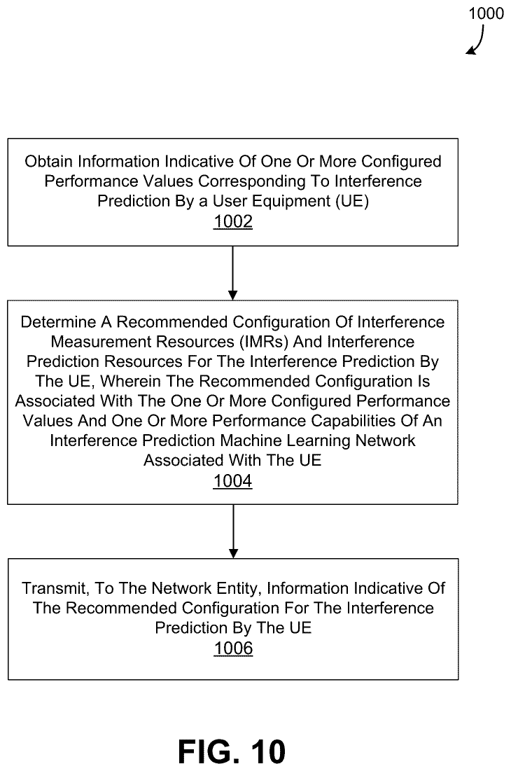

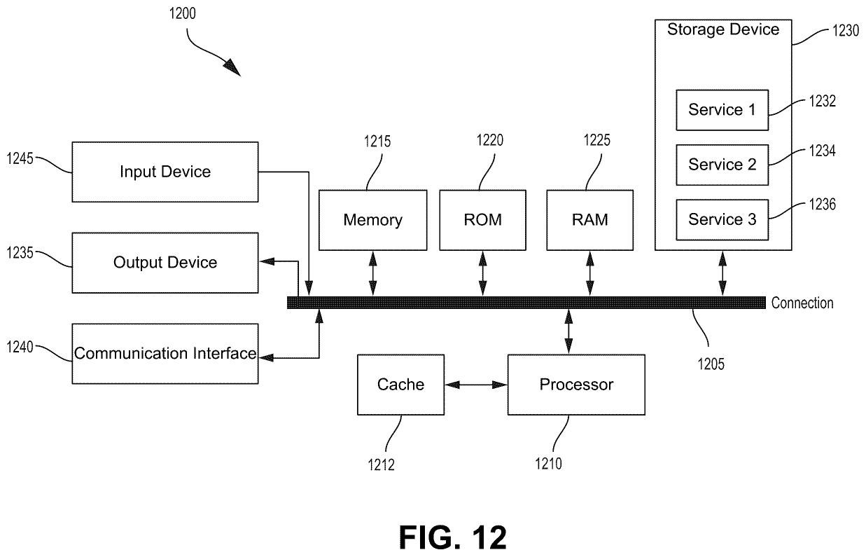

FIG. 10 is a flow diagram illustrating a process 1000 for performing wireless communications. The process 1000 can be performed by a component or system (e.g., a chipset) of a wireless device (e.g., one or more of UEs 104, 152, 164, 182, 190 of FIG. 1; UE 104 of FIG. 2; UE(s) 104 of FIG. 3; UE 407 of FIG. 4; computing system 1200 of FIG. 12; etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., processor 484 of FIG. 4, processor 1210 of FIG. 12, and/or other processor(s)). Further, the transmission and reception of signals by the wireless device in the process 1000 may be enabled, for example, by one or more antennas (e.g., antennas 252 of FIG. 2, antenna 487 of FIG. 4, etc.) and/or one or more transceivers (e.g., wireless transceiver(s) 478 of FIG. 4, etc.).

At block 1002, the process 1000 includes obtaining information indicative of one or more configured performance values corresponding to interference prediction by the UE. For instance, the UE can be the same as or similar to the UE 904 of FIG. 9, and the information indicative of the one or more configured performance values can be obtained from a network entity the same as or similar to the network entity 905 of FIG. 9.

In some cases, the one or more configured performance values includes one or more of a configured prediction accuracy or a configured prediction confidence associated with the interference prediction by the UE. In some cases, the interference prediction by the UE can be performed using an interference prediction engine such as the interference prediction engine 750 of FIG. 7. In some examples, the configured prediction accuracy comprises a configured threshold value of a Mean Square Error (MSE) associated with the interference prediction by the UE.

In some cases, the one or more configured performance values includes a minimum interference prediction accuracy for interference prediction using an interference prediction machine learning network, or a minimum interference prediction confidence for interference prediction using the interference prediction machine learning network. In some examples, the interference prediction machine learning network can be included in and/or implemented using the interference prediction engine 750 of FIG. 7.

In some cases, the information indicative of the one or more configured performance values can be the same as or similar to the configuration information 920 of FIG. 9.

At block 1004, the process 1000 includes determining a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE.

For instance, the recommended configuration can be included in configuration information determined by the UE, such as the configuration information 822a of FIG. 8A, the configuration information 822b of FIG. 8B, etc. In some cases, the recommended configuration can be the same as or similar to the recommended configuration determined at block 930 of FIG. 9, and/or the recommended interference prediction configuration information 940 transmitted from the UE 904 to the network entity 905 of FIG. 9.

In some cases, the IMRs can be the same as or similar to the IMRs 832 of FIG. 8A and/or FIG. 8B. In some examples, the interference prediction resources can be the same as or similar to the interference prediction resources 836 of FIG. 8A and/or FIG. 8B.

In some cases, the performance capabilities of the interference prediction machine learning network are indicative of a duration of time for which the one or more configured performance values are valid. In some examples, the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

In some cases, the recommended configuration is indicative of one or more of a respective periodicity of the IMRs or a respective periodicity of the interference prediction resources. In some examples, the recommended configuration is indicative of a quantity of IMRs associated with each respective interference prediction resource of a plurality of interference prediction resources for the UE. In some cases, the recommended configuration is indicative of a time separation between IMRs and interference prediction resources scheduled for the UE by the network entity based on the recommended configuration.

At block 1006, the process 1000 includes transmitting, to the network entity, information indicative of the recommended configuration for the interference prediction by the UE. For instance, the information indicative of the recommended configuration can be included in and/or can be the same as or similar to the configuration information 822a of FIG. 8A and/or the configuration information 822b of FIG. 8B. In some cases, the information indicative of the recommended configuration can be the same as or similar to the interference prediction configuration information 940, indicative of the recommended configuration 930 of FIG. 9.

In some cases, to transmit the information indicative of the recommended configuration, the UE is configured to perform static reporting using a Radio Resource Control (RRC) message indicative of the recommended configuration. In some examples, to transmit the information indicative of the recommended configuration, the UE is configured to perform semi-static reporting using a Media Access Control (MAC)-Control Element (MAC-CE) indicative of the recommended configuration. In some cases, to transmit the information indicative of the recommended configuration, the UE is configured to perform dynamic reporting using Uplink Control Information (UCI) indicative of the recommended configuration.

In some examples, the process 1000 further includes transmitting, to the network entity, information indicative of the one or more performance capabilities of the interference prediction machine learning network. For instance, the one or more performance capabilities of the interference prediction machine learning network and the recommended configuration of IMRs and interference prediction resources can be included in an interference prediction report transmitted to the network entity by the UE.

In some cases, the process 1000 further includes receiving, from the network entity, in response to the recommended configuration transmitted by the UE, scheduling information corresponding to a plurality of IMRs and interference prediction resources scheduled for the UE by the network entity. For instance, the scheduling information can be the same as or similar to scheduling information associated with the configured interference measurement resources 950 of FIG. 9, transmitted from the network entity 905 to the UE 904 of FIG. 9.

In some examples, the UE can determine, using the interference prediction machine learning network, a predicted interference value, wherein the predicted interference value is determined using the plurality of IMRs and interference prediction resources. In some examples, the one or more configured performance values includes a configured interference prediction accuracy threshold value and a configured interference prediction confidence threshold value. In some cases, the predicted interference value is associated with an accuracy value greater than or equal to the configured interference prediction accuracy threshold value. In some cases, the predicted interference value is associated with a confidence value greater than or equal to the configured interference prediction confidence threshold value.

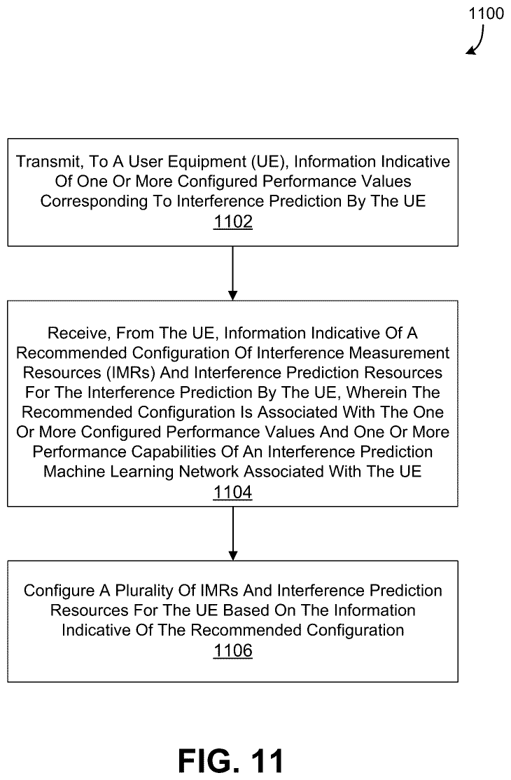

FIG. 11 is a flow diagram illustrating a process 1100 for performing wireless communications. The process 1100 can be performed by a component or system (e.g., a chipset) of a network entity (e.g., a base station, gNB, etc.). For instance, the network entity can be the same as or similar to one or more of the base stations 102 of FIG. 1, the mmW base station 180 of FIG. 1, the AP 150 of FIG. 1, the base station 102 of FIG. 2, one or more base stations or network entities of FIG. 3, the base stations 102 of FIG. 5, computing system 1200 of FIG. 12; etc.). The operations of the process 1100 may be implemented as software components that are executed and run on one or more processors (e.g., processor 484 of FIG. 4, processor 1210 of FIG. 12, and/or other processor(s)). Further, the transmission and reception of signals by the network entity in the process 1100 may be enabled, for example, by one or more antennas (e.g., antennas 252 of FIG. 2, antenna 487 of FIG. 4, etc.) and/or one or more transceivers (e.g., wireless transceiver(s) 478 of FIG. 4, etc.).

At block 1102, the process 1100 includes transmitting, to a user equipment (UE), information indicative of one or more configured performance values corresponding to interference prediction by the UE. For instance, the information indicative of the one or more configured performance values can be included in and/or can be the same as or similar to the configuration information 920 of FIG. 9. In some cases, the one or more configured performance values includes a configured interference prediction accuracy threshold value and a configured interference prediction confidence threshold value.

In some cases, the network entity can receive, from the UE, a predicted interference value determined based on the plurality of IMRs and interference prediction resources. In some examples, the predicted interference value is associated with an accuracy value greater than or equal to the configured interference prediction accuracy threshold value. In some cases, the predicted interference value is associated with a confidence value greater than or equal to the configured interference prediction confidence threshold value.

At block 1104, the process 1100 includes receiving, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE.

In some cases, the process 1100 further includes receiving, from the UE, information indicative of the one or more performance capabilities of the interference prediction machine learning network. In some cases, the performance capabilities of the interference prediction machine learning network are indicative of a future time slot where the interference prediction by the UE is associated with respective performance values below the one or more configured performance values.

In some cases, the network entity can determine a second configuration of IMRs and interference prediction resources for the UE, wherein the second configuration is based on the performance capabilities of the interference prediction machine learning network, the one or more configured performance values, and at least a portion of the recommended configuration from the UE. In some examples, to configure the plurality of IMRs and interference prediction resources, the network entity is configured to transmit, to the UE, in response to the recommended configuration received from the UE, scheduling information indicative of the second configuration of IMRs and interference prediction resources.

In some examples, the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

In some cases, the recommended configuration is indicative of one or more of a respective periodicity of the IMRs or a respective periodicity of the interference prediction resources. In some examples, the recommended configuration is indicative of one or more of a quantity of IMRs associated with each respective interference prediction resource of a plurality of interference prediction resources for the UE, or a time separation between IMRs and interference prediction resources scheduled for the UE by the network entity based on the recommended configuration. In some examples, the information indicative of the recommended configuration is included in a Radio Resource Control (RRC) message, a Media Access Control (MAC)-Control Element (MAC-CE), or Uplink Control Information (UCI) received from the UE.

At block 1106, the process 1100 includes configuring a plurality of IMRs and interference prediction resources for the UE based on the information indicative of the recommended configuration. For instance, the network entity can transmit configured interference measurement resources the same as or similar to the configured interference measurement resources 950 of FIG. 9.

FIG. 12 is a diagram illustrating an example of a system for implementing certain aspects of the present technology. In particular, FIG. 12 illustrates an example of computing system, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects and examples, computing system 1200 is a distributed system in which the functions described in this disclosure may be distributed within a datacenter, multiple data centers, a peer network, etc. In some aspects and examples, one or more of the described system components represents many such components each performing some or all of the function for which the component is described. In some aspects and examples, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects and examples, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects and examples may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects, the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus of a user equipment (UE) for wireless communication, comprising: at least one memory; and at least one processor coupled to the at least one memory, wherein the at least one processor is configured to: obtain information indicative of one or more configured performance values corresponding to interference prediction by the UE; determine a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and transmit, to the network entity, information indicative of the recommended configuration for the interference prediction by the UE.

Aspect 2. The apparatus of Aspect 1, wherein the at least one processor is further configured to: transmit, to the network entity, information indicative of the one or more performance capabilities of the interference prediction machine learning network.

Aspect 3. The apparatus of Aspect 2, wherein the one or more performance capabilities of the interference prediction machine learning network and the recommended configuration of IMRs and interference prediction resources are included in an interference prediction report transmitted to the network entity by the UE.

Aspect 4. The apparatus of any of Aspects 1 to 3, wherein the at least one processor is further configured to: receive, from the network entity, in response to the recommended configuration transmitted by the UE, scheduling information corresponding to a plurality of IMRs and interference prediction resources scheduled for the UE by the network entity.

Aspect 5. The apparatus of Aspect 4, wherein the at least one processor is further configured to: determine, using the interference prediction machine learning network, a predicted interference value, wherein the predicted interference value is determined using the plurality of IMRs and interference prediction resources.

Aspect 6. The apparatus of Aspect 5, wherein: the one or more configured performance values includes a configured interference prediction accuracy threshold value and a configured interference prediction confidence threshold value; the predicted interference value is associated with an accuracy value greater than or equal to the configured interference prediction accuracy threshold value; and the predicted interference value is associated with a confidence value greater than or equal to the configured interference prediction confidence threshold value.

Aspect 7. The apparatus of any of Aspects 1 to 6, wherein the one or more configured performance values includes one or more of a configured prediction accuracy or a configured prediction confidence associated with the interference prediction by the UE.

Aspect 8. The apparatus of Aspect 7, wherein the configured prediction accuracy comprises a configured threshold value of a Mean Square Error (MSE) associated with the interference prediction by the UE.

Aspect 9. The apparatus of any of Aspects 1 to 8, wherein the one or more configured performance values includes a minimum interference prediction accuracy for interference prediction using the interference prediction machine learning network, or a minimum interference prediction confidence for interference prediction using the interference prediction machine learning network.

Aspect 10. The apparatus of any of Aspects 1 to 9, wherein the performance capabilities of the interference prediction machine learning network are indicative of a duration of time for which the one or more configured performance values are valid.

Aspect 11. The apparatus of any of Aspects 1 to 10, wherein the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

Aspect 12. The apparatus of any of Aspects 1 to 11, wherein the recommended configuration is indicative of one or more of a respective periodicity of the IMRs or a respective periodicity of the interference prediction resources.

Aspect 13. The apparatus of any of Aspects 1 to 12, wherein the recommended configuration is indicative of a quantity of IMRs associated with each respective interference prediction resource of a plurality of interference prediction resources for the UE.

Aspect 14. The apparatus of any of Aspects 1 to 13, wherein the recommended configuration is indicative of a time separation between IMRs and interference prediction resources scheduled for the UE by the network entity based on the recommended configuration.

Aspect 15. The apparatus of any of Aspects 1 to 14, wherein, to transmit the information indicative of the recommended configuration, the at least one processor is configured to perform static reporting using a Radio Resource Control (RRC) message indicative of the recommended configuration.

Aspect 16. The apparatus of any of Aspects 1 to 15, wherein, to transmit the information indicative of the recommended configuration, the at least one processor is configured to perform semi-static reporting using a Media Access Control (MAC)-Control Element (MAC-CE) indicative of the recommended configuration.

Aspect 17. The apparatus of any of Aspects 1 to 16, wherein, to transmit the information indicative of the recommended configuration, the at least one processor is configured to perform dynamic reporting using Uplink Control Information (UCI) indicative of the recommended configuration.

Aspect 18. An apparatus of a network entity for wireless communication, comprising: at least one memory; and at least one processor coupled to the at least one memory, wherein the at least one processor is configured to: transmit, to a user equipment (UE), information indicative of one or more configured performance values corresponding to interference prediction by the UE; receive, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and configure a plurality of IMRs and interference prediction resources for the UE based on the information indicative of the recommended configuration.

Aspect 19. The apparatus of Aspect 18, wherein the at least one processor is further configured to: receive, from the UE, information indicative of the one or more performance capabilities of the interference prediction machine learning network.

Aspect 20. The apparatus of Aspect 19, wherein the performance capabilities of the interference prediction machine learning network are indicative of a future time slot where the interference prediction by the UE is associated with respective performance values below the one or more configured performance values.

Aspect 21. The apparatus of any of Aspects 19 to 20, wherein the at least one processor is configured to: determine a second configuration of IMRs and interference prediction resources for the UE, wherein the second configuration is based on the performance capabilities of the interference prediction machine learning network, the one or more configured performance values, and at least a portion of the recommended configuration from the UE.

Aspect 22. The apparatus of Aspect 21, wherein, to configure the plurality of IMRs and interference prediction resources, the at least one processor is configured to: transmit, to the UE, in response to the recommended configuration received from the UE, scheduling information indicative of the second configuration of IMRs and interference prediction resources.

Aspect 23. The apparatus of any of Aspects 18 to 22, wherein: the one or more configured performance values includes a configured interference prediction accuracy threshold value and a configured interference prediction confidence threshold value; and the at least one processor is configured to receive, from the UE, a predicted interference value determined based on the plurality of IMRs and interference prediction resources.

Aspect 24. The apparatus of Aspect 23, wherein: the predicted interference value is associated with an accuracy value greater than or equal to the configured interference prediction accuracy threshold value; and the predicted interference value is associated with a confidence value greater than or equal to the configured interference prediction confidence threshold value.

Aspect 25. The apparatus of any of Aspects 18 to 24, wherein the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

Aspect 26. The apparatus of any of Aspects 18 to 25, wherein the recommended configuration is indicative of one or more of a respective periodicity of the IMRs or a respective periodicity of the interference prediction resources.

Aspect 27. The apparatus of any of Aspects 18 to 26, wherein the recommended configuration is indicative of one or more of a quantity of IMRs associated with each respective interference prediction resource of a plurality of interference prediction resources for the UE, or a time separation between IMRs and interference prediction resources scheduled for the UE by the network entity based on the recommended configuration.

Aspect 28. The apparatus of any of Aspects 18 to 27, wherein the information indicative of the recommended configuration is included in a Radio Resource Control (RRC) message, a Media Access Control (MAC)-Control Element (MAC-CE), or Uplink Control Information (UCI) received from the UE.

Aspect 29. A method for wireless communication by a user equipment (UE), comprising: obtaining information indicative of one or more configured performance values corresponding to interference prediction by the UE; determining a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and transmitting, to the network entity, information indicative of the recommended configuration for the interference prediction by the UE.

Aspect 30. A method for wireless communication by a network entity, comprising: transmitting, to a user equipment (UE), information indicative of one or more configured performance values corresponding to interference prediction by the UE; receiving, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and configuring a plurality of IMRs and interference prediction resources for the UE based on the information indicative of the recommended configuration.

Aspect 31. A non-transitory computer-readable storage medium comprising instructions stored thereon which, when executed by at least one processor, causes the at least one processor to perform operations according to any of Aspects 1 to 17.

Aspect 32. A non-transitory computer-readable storage medium comprising instructions stored thereon which, when executed by at least one processor, causes the at least one processor to perform operations according to any of Aspects 18 to 28.

Aspect 33. A non-transitory computer-readable storage medium comprising instructions stored thereon which, when executed by at least one processor, causes the at least one processor to perform operations according to Aspect 29.

Aspect 34. A non-transitory computer-readable storage medium comprising instructions stored thereon which, when executed by at least one processor, causes the at least one processor to perform operations according to Aspect 30.

Aspect 35. An apparatus comprising one or more means for performing operations according to any of Aspects 1 to 17.

Aspect 36. An apparatus comprising one or more means for performing operations according to any of Aspects 18 to 28.

Aspect 37. An apparatus comprising one or more means for performing operations according to Aspect 29.

Aspect 38. An apparatus comprising one or more means for performing operations according to Aspect 30.

What is claimed is:

1. An apparatus of a user equipment (UE) for wireless communication, comprising:
at least one memory; and
at least one processor coupled to the at least one memory, wherein the at least one processor is configured to:
obtain information indicative of one or more configured performance values corresponding to interference prediction by the UE;
determine a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and
transmit, to the network entity, information indicative of the recommended configuration for the interference prediction by the UE.

2. The apparatus of claim 1, wherein the at least one processor is further configured to:
transmit, to the network entity, information indicative of the one or more performance capabilities of the interference prediction machine learning network.

3. The apparatus of claim 2, wherein the one or more performance capabilities of the interference prediction machine learning network and the recommended configuration of IMRs and interference prediction resources are included in an interference prediction report transmitted to the network entity by the UE.

4. The apparatus of claim 1, wherein the at least one processor is further configured to:
receive, from the network entity, in response to the recommended configuration transmitted by the UE, scheduling information corresponding to a plurality of IMRs and interference prediction resources scheduled for the UE by the network entity.

5. The apparatus of claim 4, wherein the at least one processor is further configured to:
determine, using the interference prediction machine learning network, a predicted interference value, wherein the predicted interference value is determined using the plurality of IMRs and interference prediction resources.

6. The apparatus of claim 5, wherein:
the one or more configured performance values includes a configured interference prediction accuracy threshold value and a configured interference prediction confidence threshold value;
the predicted interference value is associated with an accuracy value greater than or equal to the configured interference prediction accuracy threshold value; and
the predicted interference value is associated with a confidence value greater than or equal to the configured interference prediction confidence threshold value.

7. The apparatus of claim 1, wherein the one or more configured performance values includes one or more of a configured prediction accuracy or a configured prediction confidence associated with the interference prediction by the UE.

8. The apparatus of claim 7, wherein the configured prediction accuracy comprises a configured threshold value of a Mean Square Error (MSE) associated with the interference prediction by the UE.

9. The apparatus of claim 1, wherein the one or more configured performance values includes a minimum interference prediction accuracy for interference prediction using the interference prediction machine learning network, or a minimum interference prediction confidence for interference prediction using the interference prediction machine learning network.

10. The apparatus of claim 1, wherein the performance capabilities of the interference prediction machine learning network are indicative of a duration of time for which the one or more configured performance values are valid.

11. The apparatus of claim 1, wherein the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

12. The apparatus of claim 1, wherein the recommended configuration is indicative of one or more of a respective periodicity of the IMRs or a respective periodicity of the interference prediction resources.

13. The apparatus of claim 1, wherein the recommended configuration is indicative of a quantity of IMRs associated with each respective interference prediction resource of a plurality of interference prediction resources for the UE.

14. The apparatus of claim 1, wherein the recommended configuration is indicative of a time separation between IMRs and interference prediction resources scheduled for the UE by the network entity based on the recommended configuration.

15. The apparatus of claim 1, wherein, to transmit the information indicative of the recommended configuration, the at least one processor is configured to perform static reporting using a Radio Resource Control (RRC) message indicative of the recommended configuration.

16. The apparatus of claim 1, wherein, to transmit the information indicative of the recommended configuration, the at least one processor is configured to perform semi-static reporting using a Media Access Control (MAC)-Control Element (MAC-CE) indicative of the recommended configuration.

17. The apparatus of claim 1, wherein, to transmit the information indicative of the recommended configuration, the at least one processor is configured to perform dynamic reporting using Uplink Control Information (UCI) indicative of the recommended configuration.

18. An apparatus of a network entity for wireless communication, comprising:
at least one memory; and
at least one processor coupled to the at least one memory, wherein the at least one processor is configured to:
transmit, to a user equipment (UE), information indicative of one or more configured performance values corresponding to interference prediction by the UE;
receive, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and
configure a plurality of IMRs and interference prediction resources for the UE based on the information indicative of the recommended configuration.

19. The apparatus of claim 18, wherein the at least one processor is further configured to:
receive, from the UE, information indicative of the one or more performance capabilities of the interference prediction machine learning network.

20. The apparatus of claim 19, wherein the performance capabilities of the interference prediction machine learning network are indicative of a future time slot where the interference prediction by the UE is associated with respective performance values below the one or more configured performance values.

21. The apparatus of claim 19, wherein the at least one processor is configured to:
determine a second configuration of IMRs and interference prediction resources for the UE, wherein the second configuration is based on the performance capabilities of the interference prediction machine learning network, the one or more configured performance values, and at least a portion of the recommended configuration from the UE.

22. The apparatus of claim 21, wherein, to configure the plurality of IMRs and interference prediction resources, the at least one processor is configured to:
transmit, to the UE, in response to the recommended configuration received from the UE, scheduling information indicative of the second configuration of IMRs and interference prediction resources.

23. The apparatus of claim 18, wherein:
the one or more configured performance values includes a configured interference prediction accuracy threshold value and a configured interference prediction confidence threshold value; and
the at least one processor is configured to receive, from the UE, a predicted interference value determined based on the plurality of IMRs and interference prediction resources.

24. The apparatus of claim 23, wherein:
the predicted interference value is associated with an accuracy value greater than or equal to the configured interference prediction accuracy threshold value; and
the predicted interference value is associated with a confidence value greater than or equal to the configured interference prediction confidence threshold value.

25. The apparatus of claim 18, wherein the recommended configuration is indicative of a type of reference signal for the IMRs, and wherein the type of reference signal for the IMRs comprises one of Channel State Information (CSI)-Reference Signal (CSI-RS), CSI-Interference Measurement (CSI-IM), Physical Downlink Shared Channel (PDSCH)-Demodulation Reference Signal (PDSCH-DMRS), or PDSCH-null tones.

26. The apparatus of claim 18, wherein the recommended configuration is indicative of one or more of a respective periodicity of the IMRs or a respective periodicity of the interference prediction resources.

27. The apparatus of claim 18, wherein the recommended configuration is indicative of one or more of a quantity of IMRs associated with each respective interference prediction resource of a plurality of interference prediction resources for the UE, or a time separation between IMRs and interference prediction resources scheduled for the UE by the network entity based on the recommended configuration.

28. The apparatus of claim 18, wherein the information indicative of the recommended configuration is included in a Radio Resource Control (RRC) message, a Media Access Control (MAC)-Control Element (MAC-CE), or Uplink Control Information (UCI) received from the UE.

29. A method for wireless communication by a user equipment (UE), comprising:
obtaining information indicative of one or more configured performance values corresponding to interference prediction by the UE;
determining a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and
transmitting, to the network entity, information indicative of the recommended configuration for the interference prediction by the UE.

30. A method for wireless communication by a network entity, comprising:
transmitting, to a user equipment (UE), information indicative of one or more configured performance values corresponding to interference prediction by the UE;
receiving, from the UE, information indicative of a recommended configuration of interference measurement resources (IMRs) and interference prediction resources for the interference prediction by the UE, wherein the recommended configuration is associated with the one or more configured performance values and one or more performance capabilities of an interference prediction machine learning network associated with the UE; and
configuring a plurality of IMRs and interference prediction resources for the UE based on the information indicative of the recommended configuration.
